(19) United States
(12) Patent Application Publication
(10) Pub. No.: US 2026/0186354 A1
(43) Pub. Date: Jul. 2, 2026

(54) LIQUID CRYSTAL OPTICAL ELEMENT AND LIGHTING DEVICE

(71) Applicant: Japan Display Inc., Tokyo (JP)

(72) Inventors: Takeo KOITO, Tokyo (JP); Tae KUROKAWA, Tokyo (JP)

(21) Appl. No.: 19/545,848

(22) Filed: Feb. 20, 2026

Related U.S. Application Data
(63) Continuation of application No. PCT/JP2024/025916, filed on Jul. 19, 2024.

(30) Foreign Application Priority Data
Sep. 21, 2023 (JP) 2023-156509

(51) Int. Cl. G02F 1/1347; G02F 1/133; G02F 1/1335; G02F 1/13357; G02F 1/1337; G02F 1/1343

(52) U.S. Cl. CPC G02F 1/13471; G02F 1/13306; G02F 1/133531; G02F 1/133565; G02F 1/133603; G02F 1/133776; G02F 1/134309; G02F 1/13439; G02F 2201/122

(57) ABSTRACT

A liquid crystal optical element includes a first liquid crystal cell and a second liquid crystal cell overlapping the first liquid crystal cell. Each of the first liquid crystal cell and the second liquid crystal cell includes a first substrate, a first electrode and a second electrode arranged on the first substrate, a second substrate arranged opposite the first substrate, a third electrode and a fourth electrode arranged on the second substrate, and a liquid crystal layer arranged between the first substrate and the second substrate. The first electrode overlaps a first end of the third electrode, a space between the third electrode and the fourth electrode, and the first end of the fourth electrode. The fourth electrode overlaps a space between the first electrode and the second electrode and a first end of the second electrode.

### CROSS-REFERENCE TO RELATED APPLICATIONS

This application is a Continuation of International Patent Application No. PCT/JP2024/025916, filed on Jul. 19, 2024, which claims the benefit of priority to Japanese Patent Application No. 2023-156509, filed on Sep. 21, 2023, the entire contents of which are incorporated herein by reference.

### FIELD

An embodiment of the present invention relates to an element that utilizes optical properties of liquid crystals to control light distribution, and a lighting device including an element that utilizes the optical properties of liquid crystals to control light distribution.

### BACKGROUND

A liquid crystal lens is known as an optical element (liquid crystal optical element) that uses liquid crystals and electrically controls the focal length by supplying a voltage to the liquid crystals to change the refractive index of the liquid crystals. For example, a lighting device capable of controlling the spread of light using the liquid crystal lens is known.

### SUMMARY

A liquid crystal optical element according to an embodiment of the present invention includes: a first liquid crystal cell; and a second liquid crystal cell overlapping the first liquid crystal cell, wherein each of the first liquid crystal cell and the second liquid crystal cell includes a first substrate, a first electrode and a second electrode arranged on the first substrate, a second substrate arranged opposite the first substrate, a third electrode and a fourth electrode arranged on the second substrate, and a liquid crystal layer arranged between the first substrate and the second substrate, the first electrode and the second electrode are alternately arranged parallel to a first direction, and extend in a second direction intersecting the first direction, the third electrode and the fourth electrode are arranged alternately parallel to the first direction, and extend in the second direction, the first electrode overlaps a first end of the third electrode, a space between the third electrode and the fourth electrode, and a first end of the fourth electrode in a third direction intersecting the first direction and the second direction, and the fourth electrode overlaps a space between the first electrode and the second electrode and a first end of the second electrode in the third direction.

A lighting device according to an embodiment of the present invention includes: a first liquid crystal cell; and a second liquid crystal cell overlapping the first liquid crystal cell, wherein each of the first liquid crystal cell and the second liquid crystal cell includes a first substrate, a first electrode and a second electrode arranged on the first substrate, a second substrate arranged opposite the first substrate, a third electrode and a fourth electrode arranged on the second substrate, and a liquid crystal layer arranged between the first substrate and the second substrate, the first electrode and the second electrode are alternately arranged parallel to a first direction, and extend in a second direction intersecting the first direction, the third electrode and the fourth electrode are arranged alternately parallel to the first direction, and extend in the second direction, the first electrode overlaps a first end of the third electrode, a space between the third electrode and the fourth electrode, and a first end of the fourth electrode in a third direction intersecting the first direction and the second direction, and the fourth electrode is electrically connected to a space between the first electrode and the second electrode and a liquid crystal optical element overlapping a first end of the second electrode, and the liquid crystal optical element in the third direction, and supplies control signals to the first electrode, the second electrode, the third electrode, and the fourth electrode.

A lighting device according to an embodiment of the present invention includes: a first liquid crystal cell; and a second liquid crystal cell overlapping the first liquid crystal cell, wherein each of the first liquid crystal cell and the second liquid crystal cell includes a first substrate, a first electrode, a second-A electrode and a second-B electrode arranged on the first substrate, a second substrate arranged opposite the first substrate, a third-A electrode, a third-B electrode and a fourth electrode arranged on the second substrate, and a liquid crystal layer arranged between the first substrate and the second substrate, the first electrode, the second-A electrode and the second-B electrode are alternately arranged parallel to a first direction, and extend in a second direction intersecting the first direction, the third-A electrode and the third-B electrode are arranged parallel to the first direction, and extend in the second direction, the fourth electrode is arranged on the second substrate to cover the third-A electrode and the third-B electrode, the first electrode overlaps a first end of the third-A electrode and a space between the third-A electrode and the third-B electrode in a third direction intersecting the first direction and the second direction, the third-A electrode overlaps a space between the first electrode and the second-A electrode, and a first end of the second-A electrode in the third direction, and the space between the third-A electrode and the third-B electrode overlaps a space between the first electrode and the second-B electrode.

### BRIEF DESCRIPTION OF DRAWINGS

FIG. 1 is a perspective view showing a configuration of a lighting device according to a embodiment of the present invention.

FIG. 2 is a cross-sectional view showing a part of a cross-sectional structure of a liquid crystal optical element according to the first embodiment of the present invention.

FIG. 3 is a cross-sectional view showing a part of a cross-sectional structure of a liquid crystal optical element according to the first embodiment of the present invention.

FIG. 4 is a plan view showing an arrangement of electrodes of a liquid crystal optical element according to the first embodiment of the present invention.

FIG. 5 is a plan view showing an arrangement of electrodes of a liquid crystal optical element according to the first embodiment of the present invention.

FIG. 6 is a cross-sectional view showing a part of a cross-sectional structure of a liquid crystal optical element according to the first embodiment of the present invention.

FIG. 7 is a cross-sectional view for explaining a light distribution using a liquid crystal optical element according to the first embodiment of the present invention.

FIG. 8 is a cross-sectional view showing the alignment of liquid crystals in a liquid crystal layer in the liquid crystal optical element according to the first embodiment of the present invention.

FIG. 9 is a diagram showing a relationship between each region and phase difference in the liquid crystal optical element according to the first embodiment of the present invention.

FIG. 10 is a cross-sectional view showing the alignment of liquid crystals in a liquid crystal layer in the liquid crystal optical element according to the first embodiment of the present invention.

FIG. 11 is a diagram showing a relationship between each region and phase difference in the liquid crystal optical element according to the first embodiment of the present invention.

FIG. 12 is a timing chart showing voltages supplied to terminals included in a liquid crystal optical element according to the first embodiment of the present invention.

FIG. 13 is a schematic view for explaining the direction of light distribution in a lighting device according to the first embodiment of the present invention.

FIG. 14 is a schematic view showing a light source according to the first embodiment of the present invention.

FIG. 15 is a schematic view showing a light source according to the first embodiment of the present invention.

FIG. 16 is a perspective view showing a configuration of a lighting device according to a second embodiment of the present invention.

FIG. 17 is a cross-sectional view showing a part of a cross-sectional structure of a liquid crystal optical element according to the second embodiment of the present invention.

FIG. 18 is a cross-sectional view showing a part of a cross-sectional structure of a liquid crystal optical element according to the second embodiment of the present invention.

FIG. 19 is a plan view showing an arrangement of electrodes of a liquid crystal optical element according to the second embodiment of the present invention.

FIG. 20 is a plan view showing an arrangement of electrodes of a liquid crystal optical element according to the second embodiment of the present invention.

FIG. 21 is a cross-sectional view showing a part of a cross-sectional structure of a liquid crystal optical element according to the second embodiment of the present invention.

FIG. 22 is a cross-sectional view for explaining a light distribution using a liquid crystal optical element according to the second embodiment of the present invention.

FIG. 23 is a diagram showing a relationship between each region and phase difference in the liquid crystal optical element according to the second embodiment of the present invention.

FIG. 24 is a timing chart showing voltages supplied to terminals included in a liquid crystal optical element according to the second embodiment of the present invention.

FIG. 25 is a timing chart showing voltages supplied to terminals included in a liquid crystal optical element according to the second embodiment of the present invention.

FIG. 26 is a perspective view showing a configuration of a lighting device according to a third embodiment of the present invention.

FIG. 27 is a plan view showing an arrangement of electrodes of a liquid crystal optical element according to the third embodiment of the present invention.

FIG. 28 is a perspective view showing a configuration of a lighting device according to a fourth embodiment of the present invention.

FIG. 29 is a cross-sectional view showing a part of a cross-sectional structure of a liquid crystal optical element according to the fourth embodiment of the present invention.

### DESCRIPTION OF EMBODIMENTS

Hereinafter, embodiments of the present invention will be described with reference to the drawings and the like. However, the present invention can be implemented in many different ways and is not limited to the description of the embodiments exemplified below. For clarity of explanation, the drawings may be schematically represented in terms of width, thickness, shape, and the like of respective portions as compared with actual embodiments, but the drawings are merely examples, and do not limit the interpretation of the present invention. Furthermore, in the present specification and drawings, elements similar to those previously described with respect to the preceding figures may be denoted by the same reference signs or numbers followed by a letter, such as a, b, A, B, or by a number followed by a hyphen and a number, and detailed descriptions may be omitted as appropriate. In addition, the terms “first” and “second” appended to each element are convenient labels used to distinguish each element and have no further meaning unless specifically explained.

In the case where a member or region is to be “on (or under)” another member or region in the present specification, unless otherwise specified, this includes not only the case where it is directly above (or below) the other member or region, but also the case where it is above (or below) the other member or region, that is, it also includes the case where another component is included above (below) the other member or region.

Furthermore, in the present specification, when a single film is processed to form a plurality of structures, each structure may have different functions or roles, and each structure may be formed on different bases. However, the plurality of structures is derived from a film formed in the same process and same layer, and made of the same material. Therefore, the plurality of films is defined to exist in the same layer.

Furthermore, in the present specification, the expressions “α includes A, B or C,” “α includes any of A, B and C,” and “α includes one selected from a group consisting of A, B, and C” do not exclude the case where α includes a plurality of combinations of A to C unless otherwise specified. Furthermore, these expressions do not exclude the case where α includes other elements.

In the present specification, an x-axis direction, a y-axis direction intersecting the x-axis direction, and a z-axis intersecting the x-axis and the y-axis may be referred to as the first, second, and third directions, respectively. In addition, the x-axis is orthogonal to the y-axis and the z-axis is perpendicular to an xy plane (consisting of the x and y axes).

In the present specification, when the terms orthogonal, perpendicular, parallel, same and coincident are used, the orthogonal, perpendicular, same, and coincident may include tolerances within the design range.

### First Embodiment

### 1-1. Configuration of Lighting Device 100

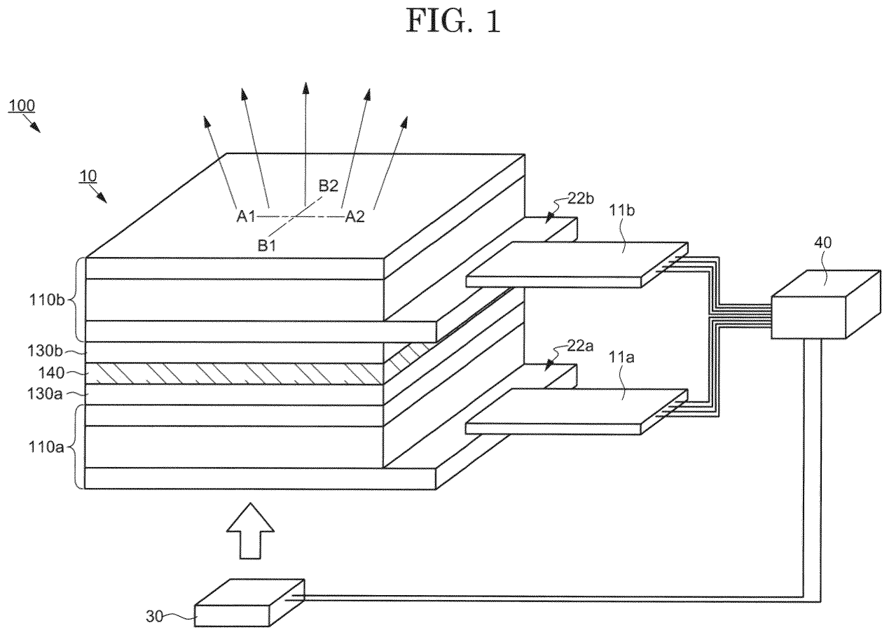

An overview of a configuration of a lighting device 100 according to a first embodiment will be described with reference to FIG. 1. FIG. 1 is a schematic perspective view showing the configuration of the lighting device 100.

As shown in FIG. 1, the lighting device 100 includes a liquid crystal optical element 10, a light source 30, and a control device 40. Although details will be described later, the liquid crystal optical element 10 includes a first liquid crystal cell 110a, an adhesive layer 130a, a wave plate 140, an adhesive layer 130b, and a second liquid crystal cell 110b. The adhesive layer 130a is provided between the first liquid crystal cell 110a and the wave plate 140, and the adhesive layer 130b is provided between the wave plate 140 and the second liquid crystal cell 110b. The first liquid crystal cell 110a, the adhesive layer 130a, the wave plate 140, the adhesive layer 130b, and the second liquid crystal cell 110b are stacked in this order along the z-axis direction, from the side closer to the light source.

The basic configuration and function of the first liquid crystal cell 110a and the second liquid crystal cell 110b are the same. Therefore, when the first liquid crystal cell 110a and the second liquid crystal cell 110b are not distinguished, the liquid crystal cell is described as a liquid crystal cell 110, and when the first liquid crystal cell 110a and the second liquid crystal cell 110b are distinguished, the liquid crystal cell is described as the first liquid crystal cell 110a and the second liquid crystal cell 110b.

The adhesive layer 130a bonds and fixes the first liquid crystal cell 110a and the wave plate 140. The adhesive layer 130b bonds and fixes the wave plate 140 and the second liquid crystal cell 110b. The material forming the adhesive layers 130a and 130b can be an optical elastic resin. For example, the optical elastic resin is an adhesive material containing a light-transmitting acrylic resin.

The wave plate 140 has a function of controlling polarization. For example, the wave plate 140 has a function of imparting a phase difference between the polarized components in the x-axis direction (P-polarized component) and the y-axis direction (S-polarized component) contained in light emitted from the light source (incident light 180) for emission. For example, the phase difference may be λ/2 or may be other than λ/2. For example, the wave plate 140 of the lighting device 100 is a wave plate with a phase difference of λ/2.

The light source 30 emits light toward the liquid crystal optical element 10. For example, the light source 30 may include a light-emitting diode (LED). The light source 30 used in the lighting device 100 is not limited to LEDs. The light source 30 may be any element or device that can emit light. In addition, the light source 30 may include a plurality of LEDs.

The control device 40 controls the liquid crystal optical element 10 and the light source 30. Specifically, the control device 40 can supply signals (voltages) that can control the light distribution direction and alignment angle to the first liquid crystal cell 110a and the second liquid crystal cell 110b of the liquid crystal optical element 10, and also supply signals (voltages) that can control the lighting and brightness of the light source 30.

The liquid crystal optical element 10 and the light source 30 are electrically connected to the control device 40. For example, the control device 40 is electrically connected to the first liquid crystal cell 110a and the second liquid crystal cell 110b of the liquid crystal optical element 10. The control device 40 is electrically connected to the liquid crystal optical element 10 via a first flexible wiring board 11a electrically connected to a terminal portion 12a of the first liquid crystal cell 110a and a second flexible wiring board 11b electrically connected to a terminal portion 12b of the second liquid crystal cell 110b.

The light emitted from the light source 30 to the liquid crystal optical element 10 transmits through the first liquid crystal cell 110a, the adhesive layer 130a, the wave plate 140, the adhesive layer 130b, and the second liquid crystal cell 110b, and is emitted from the second liquid crystal cell 110b. Although details will be described later, for instance, the light transmitted through the liquid crystal optical element 10 is refracted in the x-axis direction or y-axis direction based on the configuration of each electrode included in the liquid crystal cell 110 and the voltage supplied to each electrode from the control device 40. That is, the lighting device 100 can adjust the light distribution direction and light distribution angle using the liquid crystal optical element 10, and can irradiate light with various adjusted light distribution directions and light distribution angles.

### 1-2. Configuration of Liquid Crystal Optical Element 10

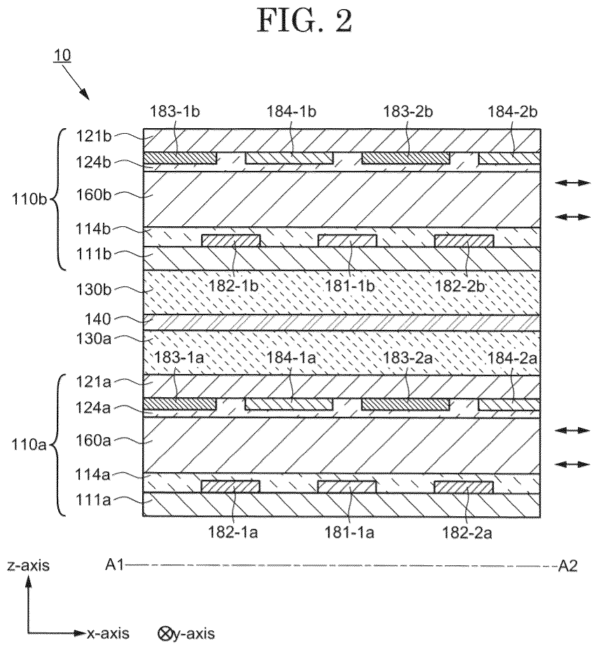

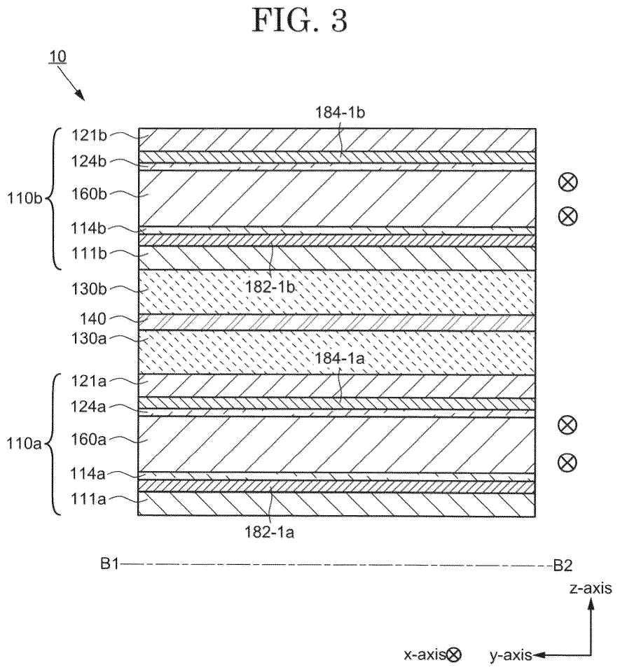

An overview of a configuration of the liquid crystal optical element 10 will be described with reference to FIG. 2 and FIG. 3. FIG. 2 and FIG. 3 are schematic cross-sectional views showing a part of a cross-sectional structure of the liquid crystal optical element 10. Specifically, FIG. 2 is a schematic cross-sectional view in a zx plane cut along a line A1-A2 shown in FIG. 1, and FIG. 3 is a schematic cross-sectional view in a yz plane cut along a line B1-B2 shown in FIG. 1. In addition, configurations that are the same as or similar to those in FIG. 1 will be described as necessary.

As described in the section “1-1. Configuration of Lighting Device 100”, the basic configuration and function of the first liquid crystal cell 110a and the second liquid crystal cell 110b are the same. In the following explanation, the configuration and function of the first liquid crystal cell 110a are described, and the configuration and function of the second liquid crystal cell 110b will be described as necessary.

The first liquid crystal cell 110a includes a first substrate 111a, a second substrate 121a, a plurality of first transparent electrodes 181 (e.g., a first transparent electrode 181-1a), a plurality of second transparent electrodes 182 (e.g., second transparent electrodes 182-1a and 182-2a), a plurality of third transparent electrodes 183 (e.g., third transparent electrodes 183-1a, 183-2a), a plurality of fourth transparent electrodes 184 (e.g., fourth transparent electrodes 184-1a and 184-2a), a first alignment film 114a, a second alignment film 124a, and a liquid crystal layer 160a.

The plurality of first transparent electrodes 181 and the plurality of second transparent electrodes 182 are provided on the first substrate 111a and covered with the first alignment film 114a. A portion of the first alignment film 114a is in contact with the first substrate 111a, the plurality of first transparent electrodes 181, and the plurality of second transparent electrodes 182.

The plurality of third transparent electrodes 183 and the plurality of fourth transparent electrodes 184 are provided on the second substrate 121a and are covered with the second alignment film 124a. A portion of the second alignment film 124a is in contact with the second substrate 121a, the plurality of third transparent electrodes 183, and the plurality of fourth transparent electrodes 184.

The first transparent electrode 181 and the second transparent electrode 182 on the first substrate 111a are arranged to face the third transparent electrode 183 and the fourth transparent electrode 184 on the second substrate 121a.

In addition, a sealing material (not shown) is provided on the periphery of the first substrate 111a and the second substrate 121a to bond the first substrate 111a and the second substrate 121a together. The liquid crystal layer 160a containing liquid crystals is provided in a space surrounded by the first substrate 111a (more specifically, the first alignment film 114a), the second substrate 121a (more specifically, the second alignment film 124a), and the sealing material.

Each of the plurality of first transparent electrodes 181, the plurality of second transparent electrodes 182, the plurality of third transparent electrodes 183, and the plurality of fourth transparent electrodes 184 extends in the y-axis direction.

In the plurality of first transparent electrodes 181 and the plurality of second transparent electrodes 182, the first transparent electrode 181 and the second transparent electrode 182 are alternately and repeatedly arranged along the x-axis direction. In the plurality of third transparent electrodes 183 and the plurality of fourth transparent electrodes 184, the third transparent electrode 183 and the fourth transparent electrode 184 are alternately and repeatedly arranged along the x-axis direction.

For example, a rigid substrate with light transmittance, such as a glass substrate, a quartz substrate, or a sapphire substrate, is used as the first substrate 111a and the second substrate 121a. For example, a flexible substrate with light transmittance, such as a polyimide resin substrate, an acrylic resin substrate, a siloxane resin substrate, or a fluororesin substrate, may also be used as the first substrate 111a and the second substrate 121a.

The plurality of first transparent electrodes 181, the plurality of second transparent electrodes 182, the plurality of third transparent electrodes 183, and the plurality of fourth transparent electrodes 184 function as electrodes for generating an electric field in the liquid crystal layer 160a. Transparent conductive materials, such as indium tin oxide (ITO) or indium zinc oxide (IZO), are used for the plurality of first transparent electrodes 181, the plurality of second transparent electrodes 182, the plurality of third transparent electrodes 183, and the plurality of fourth transparent electrodes 184.

The first alignment film 114a and the second alignment film 124a align the long axes of the liquid crystal molecules in the liquid crystal layer 160a in a predetermined direction. When no voltage is applied to each transparent electrode, the liquid crystal molecules in the liquid crystal layer 160a are aligned based on the alignment characteristics of the first alignment film 114a or the second alignment film 124a. For convenience, the long axis direction of the liquid crystal molecules in the lighting device 100 is taken as the alignment direction of the liquid crystal molecules. Polyimide resin or the like is used as the first alignment film 114a and the second alignment film 124a. The first alignment film 114a and the second alignment film 124a may be given alignment characteristics by an alignment treatment such as a rubbing method or a photo-alignment method. The rubbing method is a method in which the surface of the alignment film is rubbed in one direction. The photo-alignment method is a method in which linearly polarized ultraviolet light is irradiated onto the alignment film.

The alignment characteristics are given to the first alignment film 114a so that the alignment direction of the liquid crystal molecules on the first substrate 111a side of the first liquid crystal cell 110a is orthogonal to the extending direction of the plurality of first transparent electrodes 181 and the plurality of second transparent electrodes 182. In addition, the alignment characteristics are given to the second alignment film 124a so that the alignment direction of the liquid crystal molecules on the second substrate 121a side of the first liquid crystal cell 110a is orthogonal to the extending direction of the plurality of third transparent electrodes 183 and the plurality of fourth transparent electrodes 184. In FIG. 2 and FIG. 3, for convenience, arrows and symbols with x in circles are used to indicate the alignment direction of the liquid crystal molecules in the liquid crystal layer 160a. The arrows indicate the alignment direction of the liquid crystal molecules aligned parallel to the drawing plane, and the symbols with x in circles indicate the alignment direction of the liquid crystal molecules aligned perpendicular to the drawing plane. The alignment direction of the liquid crystal molecules on the first substrate 111a side and the alignment direction of the liquid crystal molecules on the second substrate 121a side are the x-axis direction.

The liquid crystal layer 160a contains liquid crystals. The liquid crystal layer 160a can refract the transmitted light or change the polarization of the transmitted light according to the alignment direction of the liquid crystal molecules in the liquid crystals. Nematic liquid crystal or the like is used as the liquid crystals for the liquid crystal layer 160a. The liquid crystals described in the present embodiment are a positive type, but by changing the alignment direction of the liquid crystal molecules in the state where no voltage is applied to each transparent electrode, it is possible to apply a negative type instead of the positive type. In addition, the liquid crystals preferably contain a chiral agent that imparts a twist to the liquid crystal molecules.

The second liquid crystal cell 110b includes a first substrate 111b, a second substrate 121b, the plurality of first transparent electrodes 181 (e.g., a first transparent electrode 181-1b), the plurality of second transparent electrodes 182 (e.g., second transparent electrodes 182-1b, 182-2b), the plurality of third transparent electrodes 183 (e.g., third transparent electrodes 183-1b and 183-2b), the plurality of fourth transparent electrodes 184 (e.g., fourth transparent electrodes 184-1b and 184-2b), a first alignment film 114b, a second alignment film 124b, and a liquid crystal layer 160b. The first substrate 111b, the second substrate 121b, the plurality of first transparent electrodes 181 (e.g., the first transparent electrode 181-1b), the plurality of second transparent electrodes 182 (e.g., the second transparent electrodes 182-1b and 182-2b), the plurality of third transparent electrodes 183 (e.g., the third transparent electrodes 183-1b and 183-2b), the plurality of fourth transparent electrodes 184 (e.g., the fourth transparent electrodes 184-1b and 184-2b), the first alignment film 114b, the second alignment film 124b, and the liquid crystal layer 160b each have the configuration and function similar to those of the first substrate 111a, the second substrate 121a, the plurality of first transparent electrodes 181 (e.g., the first transparent electrode 181-1a), the plurality of second transparent electrodes 182 (e.g., the second transparent electrodes 182-1a and 182-2a), the plurality of third transparent electrodes 183 (e.g., the third transparent electrodes 183-1a and 183-2a), the plurality of fourth transparent electrodes 184 (e.g., the fourth transparent electrodes 184-1a and 184-2a), the first alignment film 114a, the second alignment film 124a, and the liquid crystal layer 160a, respectively. Therefore, the description of the second liquid crystal cell 110b will be omitted here.

The first transparent electrodes 181 provided in the first liquid crystal cell 110a and the second liquid crystal cell 110b overlap so that their extending directions (y-axis direction) coincide in a plan view. Similarly, the same-named transparent electrodes provided in the first liquid crystal cell 110a and the second liquid crystal cell 110b overlap so that their extending directions (y-axis direction) coincide. That is, the lighting device 100 includes a configuration in which liquid crystal cells with the same configuration (the first liquid crystal cell 110a and the second liquid crystal cell 110b) overlap. In addition, as shown in FIG. 2 and FIG. 3, among the pair of upper and lower substrates forming the first liquid crystal cell 110a and the second liquid crystal cell 110b, the lower substrate (the substrate on the light source side) is the first substrate 111a and the first substrate 111b.

As described in the section “1-1. Configuration of Lighting Device 100,” the basic configuration and function of the first liquid crystal cell 110a and the second liquid crystal cell 110b are the same. Therefore, when the first substrate 111a and the first substrate 111b, the second substrate 121a and the second substrate 121b, the plurality of first transparent electrodes 181 (e.g., the first transparent electrodes 181-1a and 181-1b), the plurality of second transparent electrodes 182 (e.g., the second transparent electrodes 182-1a, 182-2a, 182-1b, and 182-2b), the plurality of third transparent electrodes 183 (e.g., the third transparent electrodes 183-1a, 183-2a, 183-1b, and 183-2b), the plurality of fourth transparent electrodes 184 (e.g., the fourth transparent electrodes 184-1a, 184-2a, 184-1b, and 184-2b), the first alignment film 114a and the first alignment film 114b, the second alignment film 124a and the second alignment film 124b, the liquid crystal layer 160a and the liquid crystal layer 160b are distinguished, they will be described using their respective names. When the components included in the first liquid crystal cell 110a and the second liquid crystal cell 110b described above are not distinguished, the components included in the first liquid crystal cell 110a and the second liquid crystal cell 110b will be described as the first substrate 111, the second substrate 121, the plurality of first transparent electrodes 181, the plurality of second transparent electrodes 182, the plurality of third transparent electrodes 183, the plurality of fourth transparent electrodes 184, the first alignment film 114, the second alignment film 124, and the liquid crystal layer 160, respectively.

### 1-3. Arrangement of Transparent Electrodes

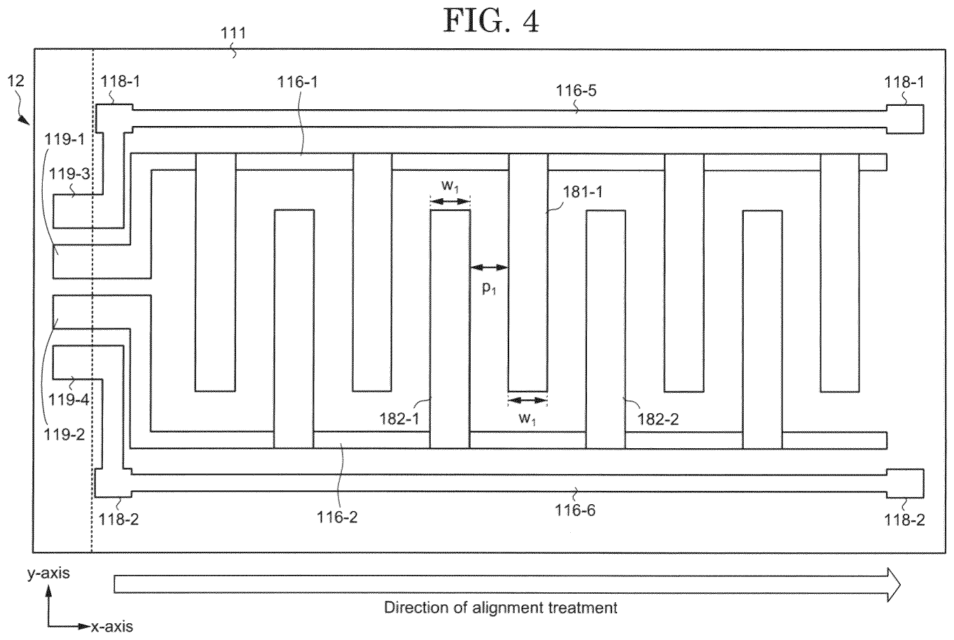

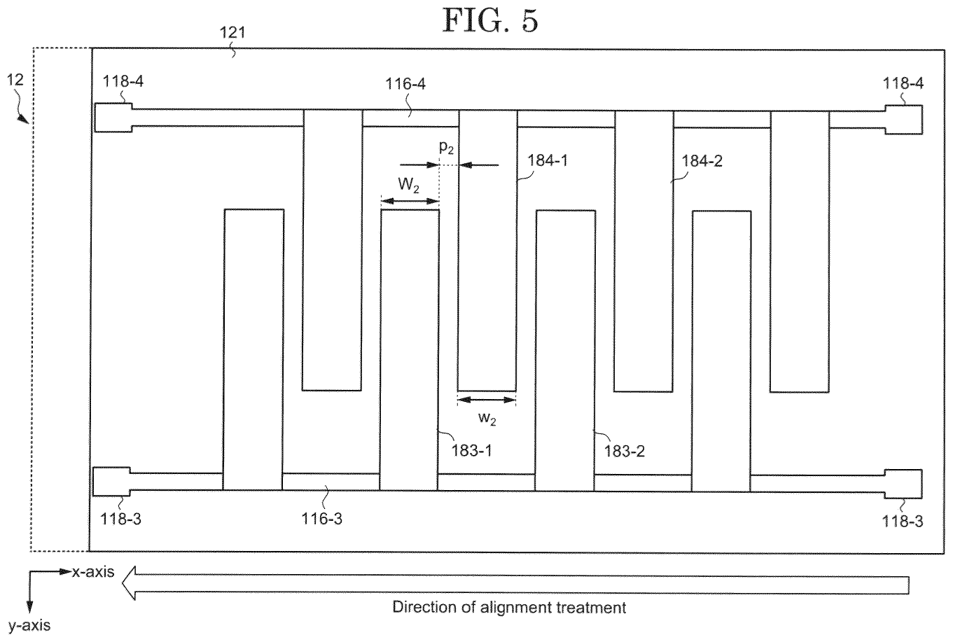

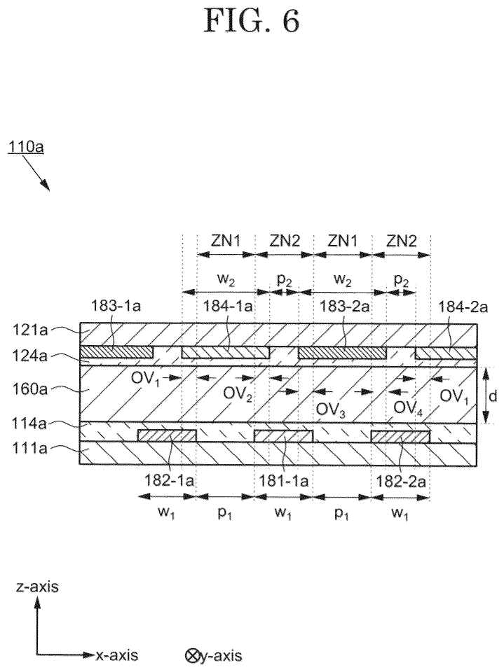

An overview of each electrode of the liquid crystal optical element 10 will be described with reference to FIG. 1 and FIG. 4 to FIG. 6. FIG. 4 is a schematic plan view showing an arrangement of the plurality of first transparent electrodes 181 and the plurality of second transparent electrodes 182 on the first substrate 111 of the liquid crystal optical element 10. FIG. 5 is a schematic plan view showing an arrangement of the plurality of third transparent electrodes 183 and the plurality of fourth transparent electrodes 184 on the second substrate 121 of the liquid crystal optical element 10. FIG. 6 is a cross-sectional view showing a part of a cross-sectional structure of the liquid crystal optical element 10. In addition, FIG. 6 corresponds to the cross-sectional structure of the first liquid crystal cell 110a along the line A1-A2 shown in FIG. 1. Configurations that are the same as or similar to those in FIG. 1 to FIG. 3 will be described as necessary.

The cross-sectional structure of the first liquid crystal cell 110a is the same as that of the second liquid crystal cell 110b, the cross-sectional structure of the first liquid crystal cell 110a will be described here, and the cross-sectional structure of the second liquid crystal cell 110b will be described as necessary.

First, an overview of each electrode of the liquid crystal optical element 10 in a plan view will be described with reference to FIG. 1, FIG. 4, and FIG. 5. As shown in FIG. 4, in a plan view, the plurality of first transparent electrodes 181, the plurality of second transparent electrodes 182, a first terminal 119-1, and a second terminal 119-2 are provided on the first substrate 111. In addition, a fifth wiring 116-5, a sixth wiring 116-6, a plurality of first power supply terminals 118-1, a plurality of second power supply terminals 118-2, a third terminal 119-3, and a fourth terminal 119-4 are provided on the first substrate 111.

The plurality of first transparent electrodes 181 and the plurality of second transparent electrodes 182 are supplied with control signals (voltages) from the control device 40, and have functions of transmitting, reducing transmission, diffusing, and refracting the light emitted from the light source 30.

The plurality of first transparent electrodes 181 includes the first transparent electrode 181-1. The plurality of second transparent electrodes 182 includes the second transparent electrode 182-1 and the second transparent electrode 182-2. The long axes of the plurality of first transparent electrodes 181 and the plurality of second transparent electrodes 182 extend in the y-axis direction, and the first transparent electrode 181 and the second transparent electrode 182 are alternately arranged along the x-axis direction.

A width of the first transparent electrode 181 and a width of the second transparent electrode 182 (width in the x-axis direction) are a first width w₁. An inter-electrode distance (electrode distance) between the first transparent electrode 181 and the second transparent electrode 182 in the x-axis direction is a first inter-electrode distance p₁. In the lighting device 100, the first width w₁ is the same as the first inter-electrode distance p₁, but the first width w₁ may be different from the first inter-electrode distance p₁. The width of the first transparent electrode 181 and the width of the second transparent electrode 182 may be different from each other.

In addition, a cell gap d is smaller (narrower) than the first width w₁ and the first inter-electrode distance p₁. For example, the cell gap d is 8 μm≤d≤50 μm, preferably 10 μm≤d≤30 μm, more preferably 15 μm≤d≤25 μm. For example, the cell gap d of the lighting device 100 is 30 μm, and the first width w₁ and the first inter-electrode distance p₁ are 35 μm. Therefore, a lateral electric field generated on the first substrate 111a side and the second substrate 112a side affects the liquid crystal molecules positioned near the center between the first substrate 111a and the second substrate 112a, and the lighting device 100 can bend the incident light 180.

The plurality of first transparent electrodes 181 is electrically connected to a first wiring 116-1, and the first wiring 116-1 is electrically connected to the first terminal 119-1. The first wiring 116-1 may be formed under the plurality of first transparent electrodes 181 or may be formed on the plurality of first transparent electrodes 181. In addition, the first wiring 116-1 may be formed in the same layer as the plurality of first transparent electrodes 181. The plurality of second transparent electrodes 182 is electrically connected to a second wiring 116-2, and the second wiring 116-2 is electrically connected to the second terminal 119-2. The second wiring 116-2 may be formed under the plurality of second transparent electrodes 182 or may be formed on the plurality of second transparent electrodes 182. In addition, the second wiring 116-2 may be formed in the same layer as the plurality of second transparent electrodes 182. For example, the plurality of first transparent electrodes 181 and the plurality of second transparent electrodes 182 of the lighting device 100 are formed in the same layer as the first wiring 116-1 and the second wiring 116-2.

The fifth wiring 116-5 is electrically connected to the plurality of first power supply terminals 118-1 and the first terminal 119-1. The sixth wiring 116-6 is electrically connected to the plurality of second power supply terminals 118-2 and the fourth terminal 119-4.

The first alignment film 114 arranged on the first substrate 111 is subjected to an alignment treatment in the x-axis direction (the direction indicated by the white arrow in FIG. 4). In this case, the long axes of the liquid crystal molecules forming the liquid crystal layer 160 on the first substrate 111 side are aligned along the x-axis direction. That is, the alignment direction (x-axis direction) of the first alignment film 114 and the extending direction (y-axis direction) of the plurality of first transparent electrodes 181 and the plurality of second transparent electrodes 182 are orthogonal.

As shown in FIG. 5, in a plan view, the plurality of third transparent electrodes 183, the plurality of fourth transparent electrodes 184, a third wiring 116-3, a fourth wiring 116-4, a plurality of third power supply terminals 118-3, and a plurality of fourth power supply terminals 118-4 are provided on the second substrate 121.

The plurality of third transparent electrodes 183 and the plurality of fourth transparent electrodes 184, similar to the plurality of first transparent electrodes 181 and the plurality of second transparent electrodes 182, are supplied with control signals (voltages) from the control device 40 and have functions of transmitting, reducing transmission, diffusing, and refracting the light emitted from the light source 30.

The plurality of third transparent electrodes 183 includes the third transparent electrode 183-1 and the third transparent electrode 183-2. The plurality of fourth transparent electrodes 184 includes the fourth transparent electrode 184-1 and the fourth transparent electrode 184-2. The long axes of the plurality of third transparent electrodes 183 and the plurality of fourth transparent electrodes 184 extend in the y-axis direction, and the third transparent electrode 183 and the fourth transparent electrode 184 are alternately arranged along the x-axis direction. A width of the third transparent electrode 183 and a width of the fourth transparent electrode 184 (width in the x-axis direction) are a second width w₂. An inter-electrode distance (electrode distance) between the third transparent electrode 183 and the fourth transparent electrode 184 in the x-axis direction is a second inter-electrode distance p₂.

In the lighting device 100, the second width w₂ is wider (thicker) than the first width w₁, and the second inter-electrode distance p₂ is narrower (thinner) than the first inter-electrode distance p₁. In addition, the width of the third transparent electrode 183 and the width of the fourth transparent electrode 184 may be different from each other.

The plurality of third transparent electrodes 183 is electrically connected to the third wiring 116-3, and the third wiring 116-3 is electrically connected to the plurality of third power supply terminals 118-3. The plurality of fourth transparent electrodes 184 is electrically connected to the fourth wiring 116-4, and the fourth wiring 116-4 is electrically connected to the plurality of fourth power supply terminals 118-4. The third wiring 116-3 may be formed under the plurality of third transparent electrodes 183 or may be formed on the plurality of third transparent electrodes 183. In addition, the third wiring 116-3 may be formed in the same layer as the plurality of third transparent electrodes 183. The fourth wiring 116-4 may be formed under the plurality of fourth transparent electrodes 184 or may be formed on the plurality of fourth transparent electrodes 184. In addition, the fourth wiring 116-4 may be formed in the same layer as the plurality of fourth transparent electrodes 184. For example, the plurality of third transparent electrodes 183, the plurality of fourth transparent electrodes 184, the third wiring 116-3, and the fourth wiring 116-4 of the lighting device 100 are formed in the same layer. In addition, the third wiring 116-3, the plurality of third power supply terminals 118-3, the fourth wiring 116-4, and the plurality of fourth power supply terminals 118-4, similar to the plurality of third transparent electrodes 183 and the plurality of fourth transparent electrodes 184, may be formed in the same layer as the third wiring 116-3 and the fourth wiring 116-4.

In the liquid crystal cell 110, the plurality of first transparent electrodes 181 and the plurality of second transparent electrodes 182 face the plurality of third transparent electrodes 183 and the plurality of fourth transparent electrodes 184 via the liquid crystal layer 160a. In addition, the extending direction (y-axis direction) of the plurality of first transparent electrodes 181 and the plurality of second transparent electrodes 182 is parallel to the extending direction (y-axis direction) of the plurality of third transparent electrodes 183 and the plurality of fourth transparent electrodes 184.

When the first substrate 111 is bonded to the second substrate 121, each of the plurality of first power supply terminals 118-1 is electrically connected to the corresponding third power supply terminal 118-3, and each of the plurality of second power supply terminals 118-2 is electrically connected to the corresponding fourth power supply terminal 118-4. As a result, the first wiring 116-1 is electrically connected to the third wiring 116-3, and the second wiring 116-2 is electrically connected to the fourth wiring 116-4. For example, the first power supply terminal 118-1 and the third power supply terminal 118-3, as well as the second power supply terminal 118-2 and the fourth power supply terminal 118-4, can be electrically connected using silver paste or conductive particles. In addition, the conductive particles include particles coated with metal.

For example, as shown in FIG. 1, FIG. 4, and FIG. 5, the length of the second substrate 121 along the x-axis direction is shorter than the length of the first substrate 111 along the x-axis direction. The first terminal 119-1, the second terminal 119-2, the third terminal 119-3, and the fourth terminal 119-4 are provided in the terminal portion 12 on the first substrate 111. As a result, when the first substrate 111 is bonded to the second substrate 121, the first terminal 119-1, the second terminal 119-2, the third terminal 119-3, and the fourth terminal 119-4 are exposed without being covered with the second substrate 121.

Therefore, in the first liquid crystal cell 110a, the terminal portion 12a can be easily bonded t the first flexible wiring board 11a, and can be easily electrically connected. As a result, the plurality of first transparent electrodes 181 is supplied with control signals (voltages) from the control device 40 (see FIG. 1) via the first flexible wiring board 11a, the terminal portion 12a, the first terminal 119-1, and the first wiring 116-1. The plurality of second transparent electrodes 182 is supplied with control signals (voltages) from the control device 40 via the first flexible wiring board 11a, the terminal portion 12a, the second terminal 119-2, and the second wiring 116-2. The plurality of third transparent electrodes 183 is supplied with control signals (voltages) from the control device 40 via the first flexible wiring board 11a, the terminal portion 12a, the third terminal 119-3, the fifth wiring 116-5, the plurality of first power supply terminals 118-1, the third wiring 116-3, and the plurality of third power supply terminals 118-3. The plurality of fourth transparent electrodes 184 is supplied with control signals (voltages) from the control device 40 via the first flexible wiring board 11a, the terminal portion 12a, the fourth terminal 119-4, the sixth wiring 116-6, the plurality of second power supply terminals 118-2, the fourth wiring 116-4, and the plurality of fourth power supply terminals 118-4. Similar to the first liquid crystal cell 110a, the terminal portion 12b of the second liquid crystal cell 110b can also be easily bonded to the second flexible wiring board 11b and easily electrically connected. In addition, similar to the first liquid crystal cell 110a, each electrode within the second liquid crystal cell 110b is also supplied with control signals (voltages) from the control device 40.

In addition, a photo spacer (not shown) may be formed on the side of the first substrate 111 facing the second substrate 121 or on the side of the second substrate 121 facing the first substrate 111. The lighting device 100 can maintain a constant distance between the first substrate 111 and the second substrate 121 by including the photo spacer.

Metal materials can be used to form the first wiring 116-1, the second wiring 116-2, the third wiring 116-3, the fourth wiring 116-4, the fifth wiring 116-5, the sixth wiring 116-6, the plurality of first power supply terminals 118-1, the plurality of third power supply terminals 118-3, the plurality of second power supply terminals 118-2, the plurality of fourth power supply terminals 118-4, the first terminal 119-1, the second terminal 119-2, the third terminal 119-3, and the fourth terminal 119-4. For example, the metal materials include aluminum and molybdenum. For example, in the case where the material forming the first wiring 116-1, the second wiring 116-2, the first terminal 119-1, and the second terminal 119-2 is metal, the material forming the plurality of first transparent electrodes 181 and the plurality of second transparent electrodes 182 is ITO or IZO, and the plurality of first transparent electrodes 181 is preferably arranged to overlap the first wiring 116-1 (opposite side of the first substrate 111), and the plurality of second transparent electrodes 182 is preferably arranged to overlap the second wiring 116-2 (opposite side of the first substrate 111). In the case where the material forming the plurality of first transparent electrodes 181 and the plurality of second transparent electrodes 182 is ITO or IZO, the plurality of first transparent electrodes 181 and the plurality of second transparent electrodes 182 are highly resistant to corrosion. The plurality of first transparent electrodes 181 and the plurality of second transparent electrodes 182, which are highly resistant to corrosion, are arranged on the first wiring 116-1, the second wiring 116-2, the first terminal 119-1, and the second terminal 119-2 (opposite side of the first substrate 111), which are made of a metal material, and corrosion of the first wiring 116-1, the second wiring 116-2, the first terminal 119-1, and the second terminal 119-2 can be suppressed.

Next, a part of the cross-sectional structure of the liquid crystal optical element 10 will be described with reference to FIG. 6.

The first transparent electrode 181-1a is sandwiched between two adjacent second transparent electrodes 182-1a and 182-2a. The first transparent electrode 181-1a overlaps in the z-axis direction with the end portion of the fourth transparent electrode 184-1a on the third transparent electrode 183-2a side, the space between the fourth transparent electrode 184-1a and the third transparent electrode 183-2a, and the end portion of the third transparent electrode 183-2a on the fourth transparent electrode 184-1a side.

The space between the first transparent electrode 181-1a and the second transparent electrode 182-1a overlaps the fourth transparent electrode 184-1a along the z-axis direction. The space between the first transparent electrode 181-1a and the second transparent electrode 182-2a overlaps the third transparent electrode 183-2a along the z-axis direction.

The second transparent electrode 182-1a overlaps along the z-axis direction with the end portion of the third transparent electrode 183-1a on the fourth transparent electrode 184-1a side, the space between the third transparent electrode 183-1a and the fourth transparent electrode 184-1a, and the end portion of the fourth transparent electrode 184-1a on the third transparent electrode 183-1a side.

The second transparent electrode 182-2a is formed in the same manner as the second transparent electrode 182-1a.

The third transparent electrode 183-2a is sandwiched between two adjacent fourth transparent electrodes 184-1a and 184-2a. The fourth transparent electrode 184-1a is sandwiched between two adjacent third transparent electrodes 183-1a and 183-2a.

The first liquid crystal cell 110a includes a plurality of first regions ZN1 and a plurality of second regions ZN2. The plurality of first regions ZN1 and the plurality of second regions ZN2 are alternately arranged along the x-axis direction.

The first region ZN1 is adjacent to the second region ZN2. In addition, the first region ZN1 includes a region where the space between the first transparent electrode 181-1a and the second transparent electrode 182-1a overlaps the fourth transparent electrode 184-1a along the z-axis direction. Furthermore, the first region ZN1 includes a region where the space between the first transparent electrode 181-1a and the second transparent electrode 182-2a overlaps the third transparent electrode 183-2a along the z-axis direction. A width OV₂ is the width along the z-axis direction where the first transparent electrode 181-1a overlaps the end portion of the fourth transparent electrode 184-1a on the third transparent electrode 183-2a side. A width OV₃ is the width along the z-axis direction where the first transparent electrode 181-1a overlaps the end portion of the third transparent electrode 183-2a on the fourth transparent electrode 184-1a side.

The second region ZN2, along the z-axis direction, includes a region where the first transparent electrode 181-1a overlaps the end portion of the fourth transparent electrode 184-1a on the third transparent electrode 183-2a side, a region which overlaps the space between the fourth transparent electrode 184-1a and the third transparent electrode 183-2a, and a region where the first transparent electrode 181-1a overlaps the end portion of the third transparent electrode 183-2a on the fourth transparent electrode 184-1a side. In addition, the second region ZN2, along the z-axis direction, includes a region where the second transparent electrode 182-2a overlaps the end portion of the third transparent electrode 183-2a on the fourth transparent electrode 184-2a side, a region which overlaps the space between the third transparent electrode 183-2a and the fourth transparent electrode 184-2a, and a region overlapping the end portion of the fourth transparent electrode 184-2a on the third transparent electrode 183-2a side. A width OV₄ is the width along the z-axis direction where the second transparent electrode 182-2a overlaps the end portion of the third transparent electrode 183-2a on the fourth transparent electrode 184-2a side. A width OV₁ is the width along the z-axis direction where the second transparent electrode 182-1a overlaps the end portion of the fourth transparent electrode 184-1a on the third transparent electrode 183-1a side, and may also be a width along the z-axis direction where the second transparent electrode 182-2a overlaps the end portion of the fourth transparent electrode 184-2a on the third transparent electrode 183-2a side.

The cell gap d may be a distance between the surface where the liquid crystal layer 160a and the first alignment film 114a contact each other and the surface where the liquid crystal layer 160a and the first alignment film 114a contact each other, or may be a distance between the first substrate 111a and the second substrate 121a. For example, the cell gap d of the lighting device 100 isa distance between the surface where the liquid crystal layer 160a and the first alignment film 114a contact each other and the surface where the liquid crystal layer 160a and the first alignment film 114a contact each other.

### 1-4. Control of Light Distribution by Liquid Crystal Optical Element 10

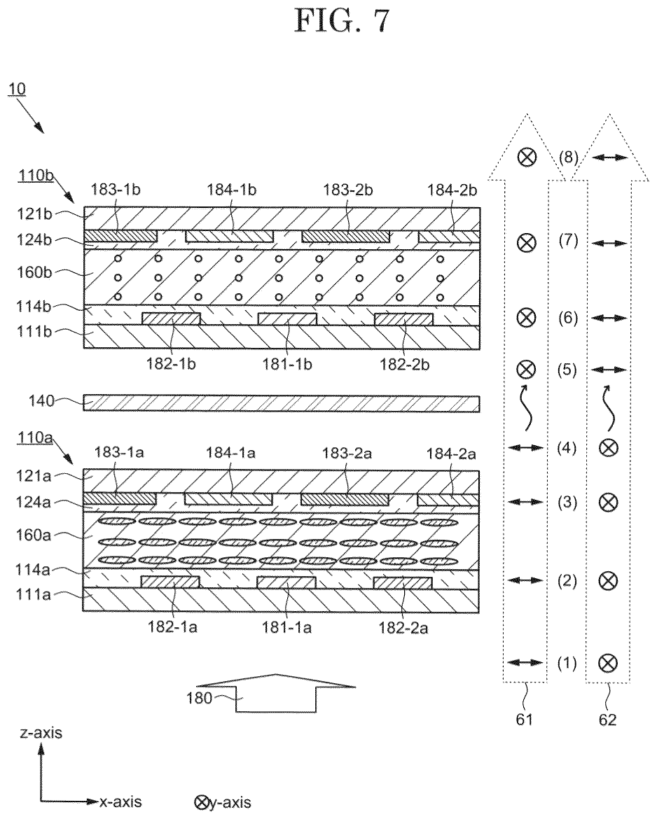

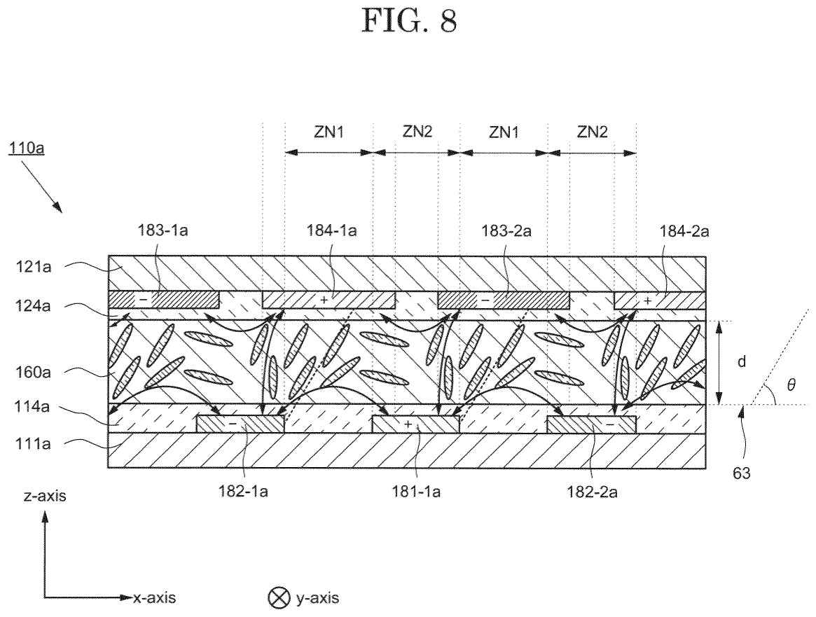

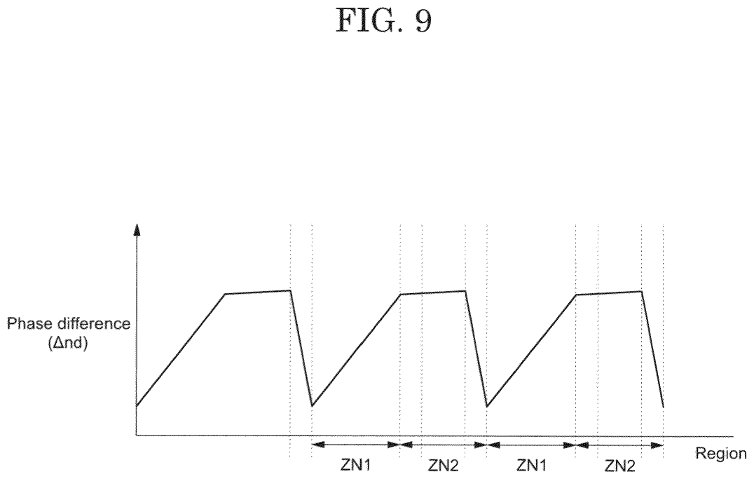

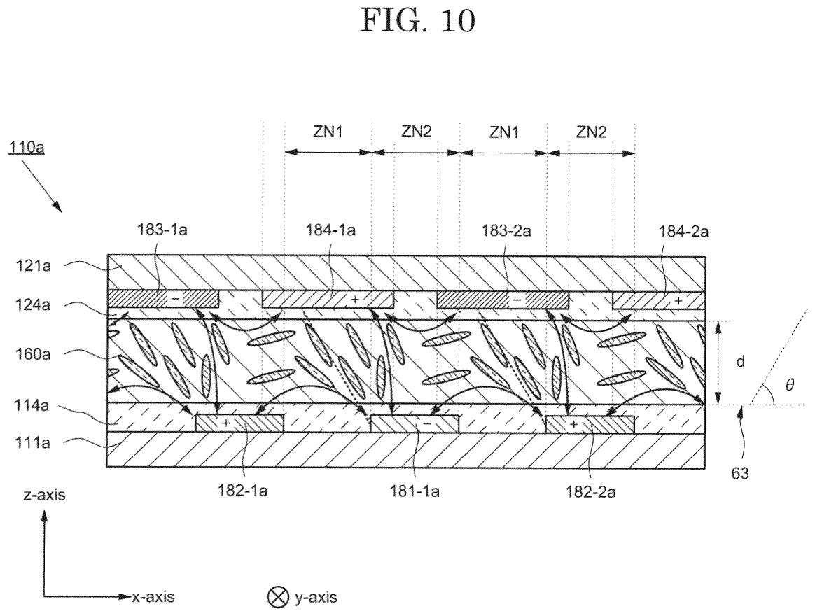

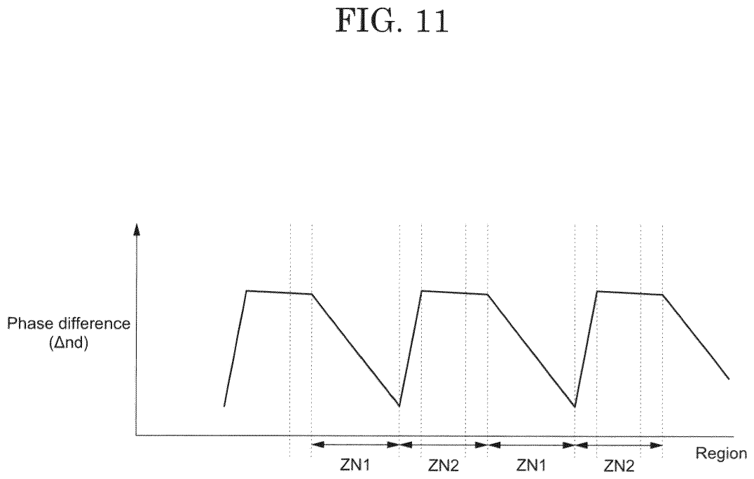

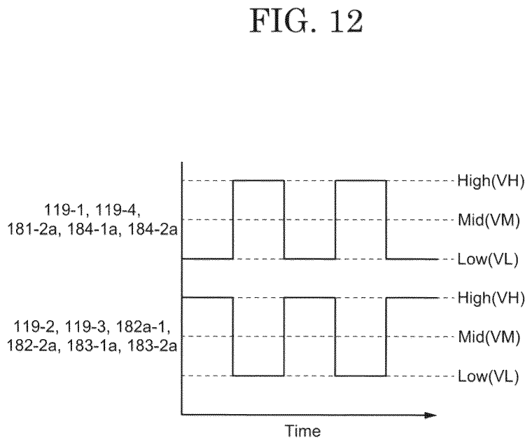

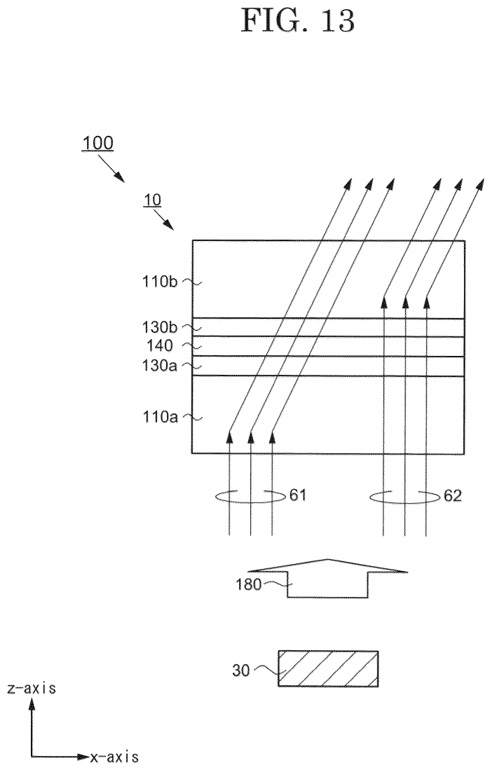

The light distribution using the liquid crystal optical element 10 will be described with reference to FIG. 7 to FIG. 13. FIG. 7 corresponds to the cross-sectional structure of the first liquid crystal cell 110a and the second liquid crystal cell 110b along the line A1-A2 shown in FIG. 1. FIG. 8 and FIG. 10 are cross-sectional views showing the alignment of liquid crystal molecules in the liquid crystal layer in the liquid crystal cell. FIG. 9 and FIG. 11 are diagrams showing a relationship between each region and the phase difference in the liquid crystal cell. FIG. 12 is a timing chart showing voltages supplied to the terminals included in the liquid crystal optical element 10. FIG. 13 is a schematic diagram for explaining the direction of light distribution in the lighting device 100. Configurations that are the same as or similar to those in FIG. 1 to FIG. 6 will be described as necessary.

In the first liquid crystal cell 110a, the first alignment film 114a is subjected to an alignment treatment along the x-axis direction and a direction away from the terminal portion 12 (see FIG. 4). The second alignment film 124a is subjected to an alignment treatment in the x-axis direction, and in a direction approaching the terminal portion 12 (see FIG. 5). Therefore, the long axes of the liquid crystal molecules on the first substrate 111a side and the long axes of the liquid crystal molecules on the second substrate 121a side are aligned in the x-axis direction. The liquid crystal molecules in the first alignment film 114b, the second alignment film 124b, and the liquid crystal layer 160b of the second liquid crystal cell 110b are composed in the same manner as those in the first liquid crystal cell 110a.

First, the liquid crystal optical element 10 in a state where no voltage is supplied to each transparent electrode of the first liquid crystal cell 110a and the second liquid crystal cell 110b will be described with reference to FIG. 7. FIG. 7 shows the liquid crystal optical element 10 in a state where no voltage is supplied to the first transparent electrodes 181-1a and 181-1b, the second transparent electrodes 182-1a, 182-2a, 182-1b, and 182-2b, the third transparent electrodes 183-1a, 183-2a, 183-1b, and 183-2b, and the fourth transparent electrodes 184-1a, 184-2a, 184-1b, and 184-2b. In FIG. 7, the adhesive layers 130a and 130b are omitted.

As shown in FIG. 7, the light emitted from the light source has the polarized components in the x-axis direction (P-polarized component) and the y-axis direction (S-polarized component), but for convenience, the light will be described by dividing it into P-polarized and S-polarized components. The light emitted from the light source (see (1) in FIG. 7) includes a first polarized light 61 having the P-polarized component and a second polarized light 62 having the S-polarized component. Arrows and the symbols with x in circles in FIG. 7 indicate the P-polarized component and the S-polarized component, respectively. The arrows indicate parallel to the x-axis, and the symbols with x in circles indicate parallel to the y-axis. The light emitted from the light source is the light incident on the liquid crystal optical element 10 (the incident light 180).

After the first polarized light 61 is incident on the first substrate 111a, the first polarized light 61 maintains the P-polarized component and is emitted from the second substrate 121a side (see (2) and (3) in FIG. 7). In addition, after the first polarized light 61 is incident on the wave plate 140, the first polarized light 61 changes from the P-polarized component to the S-polarized component as the light proceeds toward the second liquid crystal cell 110b based on the phase difference λ/2 of the wave plate 140 (see (5) in FIG. 7). Furthermore, after the first polarized light 61 is incident on the first substrate 111b, the first polarized light 61 maintains the S-polarized component and is emitted from the second substrate 121a side (see (6) to (8) in FIG. 7).

After the second polarized light 62 is incident on the first substrate 111a, the second polarized light 62 maintains the S-polarized component and is emitted from the second substrate 121a side (see (2) and (3) in FIG. 7). In addition, after the second polarized light 62 is incident on the wave plate 140, the second polarized light 62 changes from the S-polarized component to the P-polarized component as the light proceeds towards the second liquid crystal cell 110b based on the phase difference λ/2 of the wave plate 140 (see (5) in FIG. 7). Furthermore, after the second polarized light 62 is incident on the first substrate 111b, the second polarized light 62 maintains the P-polarized component and is emitted from the second substrate 121a side (see (5) to (8) in FIG. 7).

The liquid crystal optical element 10 has a structure in which two liquid crystal cells (the first liquid crystal cell 110a and the second liquid crystal cell 110b) having the same structure are stacked, and changes the polarized component of light incident on the liquid crystal optical element 10 once. As a result, the liquid crystal optical element 10 can change the polarized component before and after incidence (see (1) to (8) in FIG. 7). That is, the polarized component of the incident light 180 and the polarized component of the emitted light can be rotated by 90 degrees in the liquid crystal optical element 10.

Next, the liquid crystal optical element 10 in a state where a voltage is supplied to each transparent electrode of the first liquid crystal cell 110a will be described with reference to FIG. 8 to FIG. 13. In addition, since the configuration and function of the second liquid crystal cell 110b are similar to those of the first liquid crystal cell 110a, they will be described as necessary.

When different control signals (voltages) are supplied from the control device 40 to the first transparent electrode 181 and the second transparent electrode 182 adjacent to each other among the plurality of first transparent electrodes 181 and the plurality of second transparent electrodes 182, a voltage difference occurs between the first transparent electrode 181 and the second transparent electrode 182 adjacent to each other. As a result, an electric field (first electric field) is generated between the first transparent electrode 181 and the second transparent electrode 182 adjacent to each other. Similar to the first transparent electrode 181 and the second transparent electrode 182, different control signals (voltages) are supplied from the control device 40 to the third transparent electrode 183 and the fourth transparent electrode 184 adjacent to each other, and when a voltage difference occurs between the third transparent electrode 183 and the fourth transparent electrode 184 adjacent to each other, an electric field (second electric field) is generated between the third transparent electrode 183 and the fourth transparent electrode 184 adjacent to each other. For example, the first electric field and the second electric field are referred to as the lateral electric field.

In addition, a voltage difference occurs between the opposing first transparent electrode 181 and third transparent electrode 183, and between the opposing second transparent electrode 182 and fourth transparent electrode 184. As a result, electric fields (third electric field, fourth electric field) are generated between the opposing first transparent electrode 181 and third transparent electrode 183, and between the opposing second transparent electrode 182 and fourth transparent electrode 184. In addition, since the same control signal (voltage) is supplied between the opposing first transparent electrode 181 and fourth transparent electrode 184, and between the opposing second transparent electrode 182 and third transparent electrode 183, no voltage difference occurs.

For example, as shown in FIG. 8 and FIG. 12, a low voltage VL is supplied to the second transparent electrode 182-1a, the second transparent electrode 182-2a, the third transparent electrode 183-1a, and the third transparent electrode 183-2a, and a high voltage VH is supplied to the first transparent electrode 181-1a, the fourth transparent electrode 184-1a, and the fourth transparent electrode 184-2a. As a result, a voltage difference (VH−VL) occurs between the second transparent electrode 182-1a and the first transparent electrode 181-1a, and a lateral electric field is generated. Similarly, the voltage difference (VH−VL) occurs between the other adjacent electrodes, and a lateral electric field is generated. For example, the high voltage VH is larger (higher) than the low voltage VL, and the high voltage VH is a voltage with the polarity reversed from that of the low voltage VL. In addition, an intermediate (Mid) voltage VM is a reference voltage, which may be ground or 0 V. For example, an absolute value of the voltage difference between the high voltage VH and the intermediate voltage VM is the same as an absolute value of the voltage difference between the low voltage VL and the intermediate voltage.

In addition, the voltage difference (VH−VL) occurs between the second transparent electrode 182-1a and the fourth transparent electrode 184-1a, between the first transparent electrode 181-1a and the third transparent electrode 183-2a, and between the second transparent electrode 182-2a and the fourth transparent electrode 184-2a, and electric fields are generated. In addition, no voltage difference occurs between the first transparent electrode 181-1a and the fourth transparent electrode 184-1a, and between the second transparent electrode 182-2a and the third transparent electrode 183-2a, and no electric field is generated.

When the electric field is generated, the alignment state of the liquid crystal molecules in the liquid crystal layer 160a is affected by the electric field changes.

First, the alignment state of the liquid crystal molecules in the first region ZN1 will be described. The long axes of the liquid crystal molecules on the first substrate 111a side are aligned in a convex arc shape in the x-axis direction based on the lateral electric field between the second transparent electrode 182-1a and the first transparent electrode 181-1a. In addition, the long axes of the liquid crystal molecules are aligned and tilted from the x-axis direction to the z-axis direction based on the electric field between the second transparent electrode 182-1a and the fourth transparent electrode 184-1a, from the first substrate 111a to the second substrate 121a. In addition, the long axes of the liquid crystal molecules may be aligned and tilted from the x-axis direction to the z-axis direction under the influence of the lateral electric field between the fourth transparent electrode 184-1a and the third transparent electrode 183-2a.

Furthermore, the long axes of the liquid crystal molecules on the first substrate 111a side are aligned in a convex arc shape in the x-axis direction based on the lateral electric field between the second transparent electrode 182-1a and the first transparent electrode 181-1a. Furthermore, the long axes of the liquid crystal molecules are aligned and tilted from the x-axis direction to the z-axis direction based on the electric field between the second transparent electrode 182-1a and the fourth transparent electrode 184-1a, from the first substrate 111a to the second substrate 121a. In addition, the long axes of the liquid crystal molecules may be aligned and tilted from the x-axis direction to the z-axis direction under the influence of the lateral electric field between the fourth transparent electrode 184-1a and the third transparent electrode 183-2a.

As a result, for example, the first polarized light 61 incident on the first region ZN1 is bent at a control angle θ from the second transparent electrode 182-1a toward the fourth transparent electrode 184-1a. The first polarized light 61 incident on the first region ZN1 is bent at a control angle θ from the first transparent electrode 181-1a toward the third transparent electrode 183-2a. For example, the control angle θ is the angle formed between the long axes of the liquid crystal molecules and the incident surface 63 in a cross-sectional view.

Next, the alignment state of the liquid crystal molecules in the second region ZN2 will be described. For example, since no electric field is generated between the first transparent electrode 181-1a and the fourth transparent electrode 184-1a, the long axes of the liquid crystal molecules are aligned parallel to the x-axis. In practice, the long axes of the liquid crystal molecules may be aligned and tilted from the x-axis direction to the z-axis direction under the influence of the lateral electric fields between the second transparent electrode 182-1a and the first transparent electrode 181-1a, and between the fourth transparent electrode 184-1a and the third transparent electrode 183-2a. In addition, the long axes of the liquid crystal molecules are aligned along the z-axis direction based on the electric field between the first transparent electrode 181-1a and the third transparent electrode 183-2a. Furthermore, the long axes of the liquid crystal molecules may be tilted from the z-axis direction to the x-axis direction under the influence of the lateral electric field between the fourth transparent electrode 184-1a and the third transparent electrode 183-2a. As a result, for example, the first polarized light 61 incident on the second region ZN2 may generally proceed straight from the second transparent electrode 182-1a toward the fourth transparent electrode 184-1a, and may be tilted from the z-axis direction to the x-axis direction.

In addition, for example, since no electric field is generated between the second transparent electrode 182-1a and the third transparent electrode 183-2a, the long axes of the liquid crystal molecules are aligned parallel to the x-axis. In practice, the long axes of the liquid crystal molecules may be aligned and tilted from the x-axis direction to the z-axis direction under the influence of the lateral electric fields between the second transparent electrode 182-2a and the first transparent electrode 181-1a, and between the fourth transparent electrode 184-2a and the third transparent electrode 183-2a. In addition, the long axes of the liquid crystal molecules are aligned along the z-axis direction based on the electric field between the second transparent electrode 182-2a and the fourth transparent electrode 184-2a. Furthermore, the long axes of the liquid crystal molecules may be tilted from the z-axis direction to the x-axis direction under the influence of the lateral electric field between the fourth transparent electrode 184-1a and the third transparent electrode 183-2a. As a result, for example, the first polarized light 61 incident on the second region ZN2 generally proceeds straight from the second transparent electrode 182-2a toward the fourth transparent electrode 184-2a and may be tilted from the z-axis direction to the x-axis direction.

The alignment of the liquid crystals in each region shown in FIG. 8 can be shown as the relationship between each region and the phase difference, as shown in FIG. 9. In the present specifications and drawings, the phase difference is represented by the product of the cell gap d and the coefficient Δn, that is, Δnd. In addition, the control angle θ can be adjusted according to the voltage supplied to each electrode. For example, the control angle θ in FIG. 8 and FIG. 9 is less than 90 degrees.

As shown in FIG. 9, the phase difference of the light incident on the first region ZN1 gradually increases as the light proceeds from the first substrate 111a side toward the second substrate 121a side. The increase in the phase difference means that the light is emitted from the first substrate 111a side toward the second substrate 121a side. In other words, the light incident on the first region ZN1 is bent as the light proceeds from the first substrate 111a side toward the second substrate 121a side and is emitted from the second substrate 121a. In addition, the phase difference of the light incident on the second region ZN2 slightly increases as the light proceeds from the first substrate 111a side toward the second substrate 121a side and then decreases. The decrease in the phase difference means that the light proceeds from the second substrate 121a toward the first substrate 111a side and is not emitted from the second substrate 121a. In other words, the light incident on the second region ZN2 is not emitted from the second substrate 121a.

As shown in FIG. 8 and FIG. 9, by supplying the high voltage VH or the low voltage VL to each electrode of the lighting device 100, the lighting device 100 can bend the light incident on the incident surface 63 of the first liquid crystal cell 110a (for example, the incident light 180 (see FIG. 1)) at the control angle θ and emit the light from the first liquid crystal cell 110a. In addition, as schematically shown in FIG. 13, the bent light emitted from the first liquid crystal cell 110a transmits through the wave plate 140 and the second liquid crystal cell 110b and is emitted from the second liquid crystal cell 110b. The first polarized light 61 incident on the incident surface 63 of the first liquid crystal cell 110a is bent, rotated 90 degrees by the wave plate 140, transmitted through the second liquid crystal cell 110b, and is emitted from the liquid crystal optical element 10. Since the second polarized light 62 is rotated 90 degrees from the first polarized light 61, the second polarized light 62 transmits through the first liquid crystal cell 110a, is rotated 90 degrees by the wave plate 140, bent similarly to the second liquid crystal cell 110b, and emitted from the liquid crystal optical element 10. In addition, FIG. 13 is a diagram schematically showing the lighting device 100, and in reality, the first polarized light 61 and the second polarized light 62 are rotated 90 degrees.

For example, when the high voltage VH and the low voltage VL are set under the conditions that the cell gap d is 30 μm, the first inter-electrode distance p1 is 35 μm, and the Δn is 0.2, the control angle θ is 10 degrees. That is, under these conditions, the lighting device 100 can bend the light incident on the incident surface 63 of the first liquid crystal cell 110a at an angle of 10 degrees and emit the light from the first liquid crystal cell 110a. Furthermore, the lighting device 100 can rotate the light that is bent at an angle of 10 degrees and emitted from the first liquid crystal cell 110a by 90 degrees by the wave plate 140, then transmit the light through the second liquid crystal cell 110b, and emit the light from the liquid crystal optical element 10 (the second liquid crystal cell 110b). In addition, the lighting device 100 can transmit the light incident on the incident surface 63 of the first liquid crystal cell 110a through the first liquid crystal cell 110a and emit the light from the first liquid crystal cell 110a. Furthermore, the lighting device 100 can rotate the light emitted from the first liquid crystal cell 110a by 90 degrees by the wave plate 140, bend the light at an angle of 10 degrees in the second liquid crystal cell 110b, and emit the light from the liquid crystal optical element 10 (the second liquid crystal cell 110b).

In addition, for example, as shown in FIG. 10 and FIG. 12, the high voltage VH(+) is supplied to the second transparent electrode 182-1a, the second transparent electrode 182-2a, the fourth transparent electrode 184-1a, and the fourth transparent electrode 184-2a, and the low voltage VL(−) is supplied to the first transparent electrode 181-1a, the third transparent electrode 183-1a, and the third transparent electrode 183-2a. As a result, the voltage difference (VH−VL) occurs between the second transparent electrode 182-1a and the first transparent electrode 181-1a, and a lateral electric field is generated. Similarly, the voltage difference (VH−VL) occurs between the other adjacent electrodes, and a lateral electric field is generated.

Furthermore, the voltage difference (VH−VL) occurs between the second transparent electrode 182-1a and the fourth transparent electrode 184-1a, between the first transparent electrode 181-1a and the third transparent electrode 183-2a, and between the second transparent electrode 182-2a and the fourth transparent electrode 184-2a, and an electric field is generated. In addition, no voltage difference occurs between the second transparent electrode 182-1a and the third transparent electrode 183-1a, between the first transparent electrode 181-1a and the fourth transparent electrode 184-1a, and between the second transparent electrode 182-2a and the third transparent electrode 183-2a, and no electric field is generated.

When an electric field is generated, the alignment state of the liquid crystal molecules in the liquid crystal layer 160a affected by the electric field changes.

The polarity of the voltage supplied to the second transparent electrode 182-1a, the second transparent electrode 182-2a, and the first transparent electrode 181-1a is reversed in the configuration shown in FIG. 10 compared to the configuration shown in FIG. 8. Therefore, the direction in which the liquid crystal molecules are aligned in each region of the configuration shown in FIG. 10 is symmetrical in the z-axis direction to the direction in which the liquid crystal molecules are aligned in each region of the configuration shown in FIG. 8. An example of the direction in which the liquid crystal molecules are aligned in each region of the configuration shown in FIG. 10 will be described below, and the direction in which the liquid crystal molecules are aligned in each region of the configuration shown in FIG. 10, which will not be described, is symmetrical in the z-axis direction to the direction shown in each region of the configuration shown in FIG. 8.

For example, the alignment state of the liquid crystal molecules in the first region ZN1 will described. The long axes of the liquid crystal molecules on the first substrate 111a side are aligned in a convex arc shape in the x-axis direction based on the lateral electric field between the second transparent electrode 182-1a and the first transparent electrode 181-1a. In addition, the long axes of the liquid crystal molecules are aligned and tilted from the x-axis direction to the z-axis direction based on the electric field between the first transparent electrode 181-1a and the fourth transparent electrode 184-1a, from the first substrate 111a to the second substrate 121a. In addition, the long axes of the liquid crystal molecules may be aligned and tilted from the x-axis direction to the z-axis direction under the influence of the lateral electric field between the fourth transparent electrode 184-1a and the third transparent electrode 183-1a.

As a result, for example, the first polarized light 61 incident on the first region ZN1 is bent at the control angle θ from the first transparent electrode 181-1a toward the fourth transparent electrode 184-1a. In addition, the first polarized light 61 incident on the first region ZN1 is bent at the control angle θ from a second transparent electrode 182-3a toward the third transparent electrode 183-2a.

For example, the alignment state of the liquid crystal molecules in the second region ZN2 be described. Since no electric field is generated between the first transparent electrode 181-1a and the third transparent electrode 183-2a, the long axes of the liquid crystal molecules are aligned parallel to the x-axis. In practice, the long axes of the liquid crystal molecules may be aligned and tilted from the x-axis direction to the z-axis direction under the influence of the lateral electric fields between the second transparent electrode 182-2a and the first transparent electrode 181-1a, and between the fourth transparent electrode 184-1a and the third transparent electrode 183-2a. In addition, the long axes of the liquid crystal molecules are aligned along the z-axis direction based on the electric field between the first transparent electrode 181-1a and the fourth transparent electrode 184-1a. Furthermore, the long axes of the liquid crystal molecules may be tilted from the z-axis direction to the x-axis direction under the influence of the lateral electric field between the fourth transparent electrode 184-1a and the third transparent electrode 183-2a. As a result, for example, the first polarized light 61 incident on the second region ZN2 generally proceeds straight from the first transparent electrode 181-1a toward the fourth transparent electrode 184-1a and may be tilted from the z-axis direction to the x-axis direction. In addition, for example, the material forming the plurality of first transparent electrodes 181 and the plurality of second transparent electrodes 182 may not be a transparent material but an opaque material, such as a metal material, such as aluminum or molybdenum. In this case, since the first polarized light 61 incident on the second region ZN2 generally proceeds straight from the first transparent electrode 181-1a side toward the fourth transparent electrode 184-1a side, only the bent light is emitted.

The alignment of the liquid crystals in each region shown in FIG. 10 can be shown as the relationship between each region and the phase difference, as shown in FIG. 11. The direction in which the liquid crystal molecules are aligned in each region of the configuration shown in FIG. 10 is symmetrical in the z-axis direction to the direction in which the liquid crystal molecules are aligned in each region of the configuration shown in FIG. 8. Therefore, the tilt of the straight line in the relationship between each region and the phase difference shown in FIG. 11 is inverted to that in the relationship between each region and the phase difference shown in FIG. 9. That is, the phase difference increases from the first region ZN1 toward the second region ZN2 in the first region ZN1 shown in FIG. 9, and the phase difference increases from the second region ZN2 toward the first region ZN1 in the first region ZN1 shown in FIG. 11. Similar to the phase difference in the first region ZN1 shown in FIG. 11, the tilt of the straight line of the phase difference in the second region shown in FIG. 11 is inverted with respect to that of the phase difference in the second region shown in FIG. 9.

That is, the configuration shown in FIG. 10 and FIG. 11 is a configuration that bends light in a direction along the x-axis direction, which is the opposite direction to the configuration shown in FIG. 8 and FIG. 9. For example, the control angle θ in the configuration shown in FIG. 8 is less than 90 degrees, but the control angle θ in the configuration shown in FIG. 10 is greater than 90 degrees. For example, the lighting device 100 having the configuration shown in FIG. 10 can bend light to the left by using the conditions under which the lighting device 100 having the configuration shown in FIG. 8 bends light to the right.

As described above, the lighting device 100 can emit light bent at the control angle θ from the liquid crystal optical element 10. In addition, the lighting device 100 can supply a voltage to each electrode included in the liquid crystal optical element 10, thereby causing the light bent at the control angle θ corresponding to the supplied voltage to be emitted from the liquid crystal optical element 10. Therefore, the lighting device 100 can adjust the light distribution direction and light distribution angle using the liquid crystal optical element 10, and can irradiate light with various adjusted light distribution directions and light distribution angles.

### 1-5. Configuration of Light Source 30

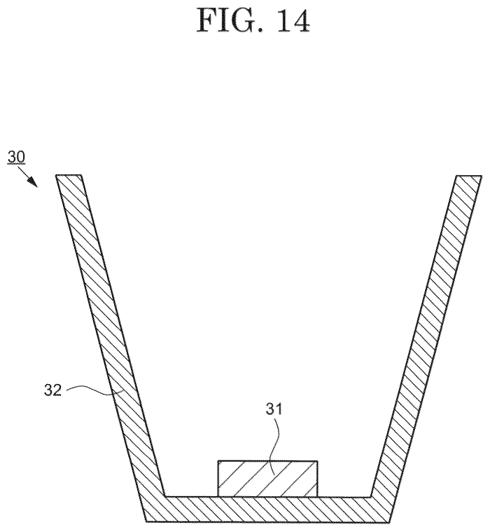

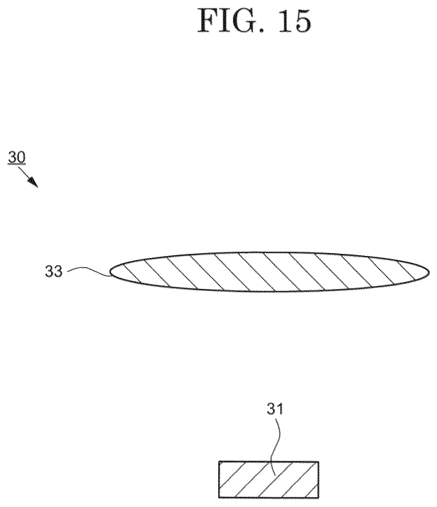

FIG. 14 and FIG. 15 are schematic views showing the light source 30. For example, as shown in FIG. 14, the light source 30 may include a light-emitting element 31 and a reflector 32, and as shown in FIG. 15, the light source 30 may include the light-emitting element 31 and a convex lens 33. In addition, the configuration and function of the light source are not limited to the configuration and function of the light source 30. For example, the light source 30 may be configured to allow for a narrow-angle light distribution.

For example, the light-emitting element 31 is an LED. The reflector 32 can reflect the light emitted from the light-emitting element 31 and emit the reflected light toward the liquid crystal optical element 10. The shape of the reflector 32 shown in FIG. 15 is approximately conical, but the shape of the reflector 32 is not limited to an approximately conical shape. In addition, the surface of the reflector 32 may be flat or curved. The convex lens 33 can collect the light emitted from the light-emitting element 31 and emit the collected light toward the liquid crystal optical element 10.

### Second Embodiment

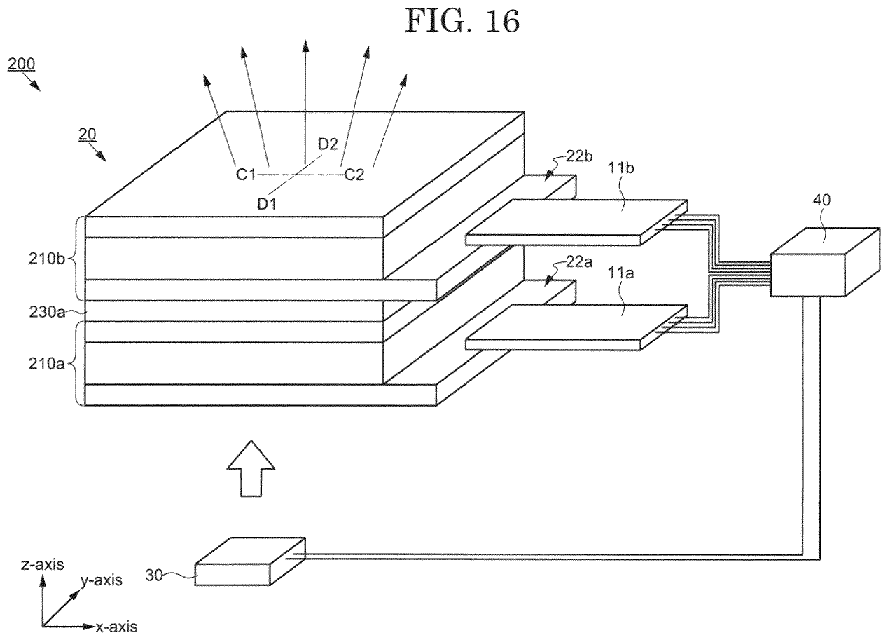

An overview of a structure of a lighting device 200 according to the second embodiment will be described with reference to FIG. 16 to FIG. 25. FIG. 16 is a schematic perspective view showing the configuration of the lighting device 200. Compared to the lighting device 100, the lighting device 200 does not include the wave plate 140, and the configuration of each electrode on the first substrate and the configuration of each electrode on the second substrate are different. Other configurations of the lighting device 200 are similar to those of the lighting device 100. Therefore, configurations similar to those of the lighting device 100 will be described when necessary. In addition, configurations that are the same as or similar to those in FIG. 1 to FIG. 15 will be described as necessary.

### 2-1. Configuration of Lighting Device 200

An overview of the configuration of the lighting device 200 will be described with reference to FIG. 16. FIG. 16 is a schematic perspective view showing the configuration of the lighting device 200.

As shown in FIG. 16, the lighting device 200 includes a liquid crystal optical element 20, the light source 30, and the control device 40. Although details will be described later, the liquid crystal optical element 20 includes a first liquid crystal cell 210a, an adhesive layer 230a, and a second liquid crystal cell 210b. The adhesive layer 230a is provided between the first liquid crystal cell 210a and the second liquid crystal cell 210b. The first liquid crystal cell 210a, the adhesive layer 230a, and the second liquid crystal cell 210b are stacked in this order along the z-axis direction, from the side closer to the light source.

The basic configuration and function of the first liquid crystal cell 210a and the second liquid crystal cell 210b are the same. Therefore, when the first liquid crystal cell 210a and the second liquid crystal cell 210b are not distinguished, the liquid crystal cell is described as a liquid crystal cell 210, and when the first liquid crystal cell 210a and the second liquid crystal cell 210b are distinguished, the liquid crystal is described as the first liquid crystal cell 210a and the second liquid crystal cell 210b.

The adhesive layer 230a bonds and fixes the first liquid crystal cell 210a and the second liquid crystal cell 210b. The material forming the adhesive layer 230a may be a material similar to that used for the adhesive layer 130a.

The light source 30 and the control device 40 have configurations similar to the lighting device 100. The control device 40 controls the liquid crystal optical element 20 and the light source 30. Specifically, the control device 40 can supply control signals (voltages) that can control the light distribution direction and alignment angle to the first liquid crystal cell 210a and the second liquid crystal cell 210b of the liquid crystal optical element 20, and also supply control signals (voltages) that can control the lighting and brightness of the light source 30.

The liquid crystal optical element 20 and the light source 30 are electrically connected to the control device 40. For example, the control device 40 is electrically connected to the first liquid crystal cell 210a and the second liquid crystal cell 210b of the liquid crystal optical element 20. The control device 40 is electrically connected to the liquid crystal optical element 20 via the first flexible wiring board 11a electrically connected to a terminal portion 22a of the first liquid crystal cell 210a and the second flexible wiring board 11b electrically connected to a terminal portion 22b of the second liquid crystal cell 210b.

The light emitted from the light source 30 to the liquid crystal optical element 20 transmits through the first liquid crystal cell 210a, the adhesive layer 230a, and the second liquid crystal cell 210b, and is emitted from the second liquid crystal cell 210b. Although details will be described later, for example, the light transmitted through the liquid crystal optical element 20 is refracted in the x-axis direction or y-axis direction based on the configuration of each electrode included in the liquid crystal cell 210 and the voltage supplied to each electrode from the control device 40. That is, the lighting device 200 can adjust the light distribution direction and light distribution angle using the liquid crystal optical element 20, and can irradiate light with various adjusted light distribution directions and light distribution angles.

### 2-2. Configuration of Liquid Crystal Optical Element 20

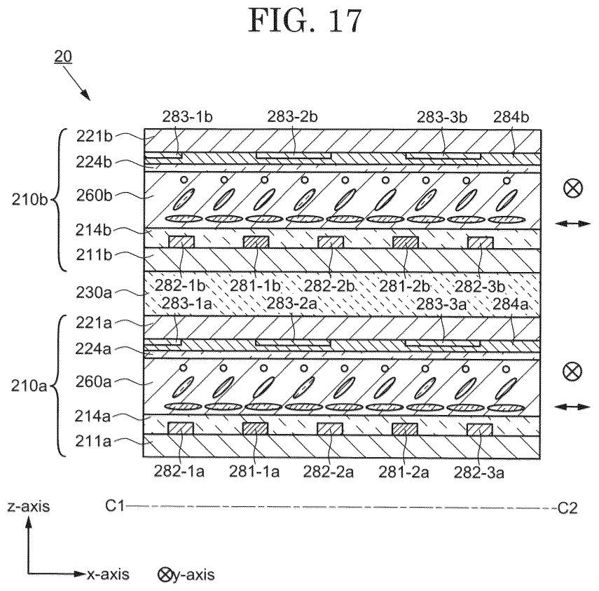

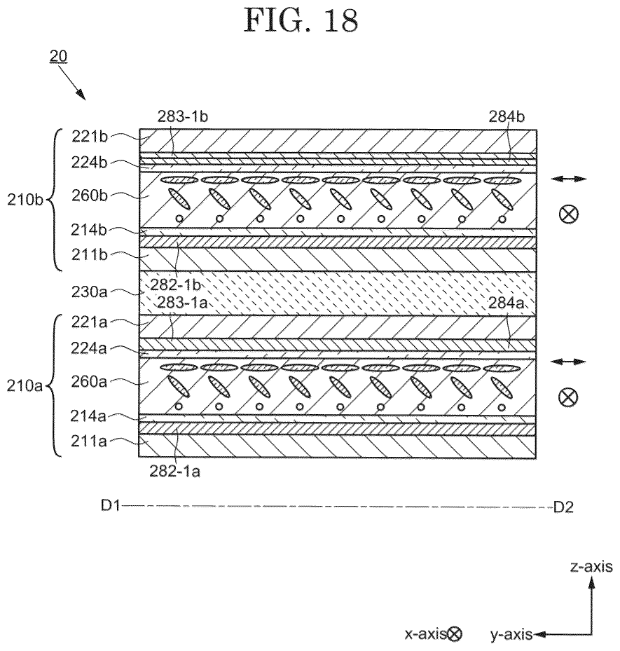

An overview of a configuration of the liquid crystal optical element 20 will be described w reference to FIG. 17 and FIG. 18. FIG. 17 and FIG. 18 are schematic cross-sectional views showing a part of a cross-sectional structure of the liquid crystal optical element 20. Specifically, FIG. 17 is a schematic cross-sectional view in a zx plane cut along a line C1-C2 shown in FIG. 16, and FIG. 18 is a schematic cross-sectional view in a yz plane cut along a line D1-D2 shown in F IG. 16. In addition, configurations that are the same as or similar to those in FIG. 16 will be described as necessary. In the following explanation, the configuration and function of the first liquid crystal cell 210a will be described, and the configuration and function of the second liquid crystal cell 210b will be described as necessary.

The first liquid crystal cell 210a includes a first substrate 211a, a second substrate 221a, a plurality of first transparent electrodes 281 (for example, a first transparent electrode 281-1a, a first transparent electrode 281-2a), a plurality of second transparent electrodes 282 (for example, a second transparent electrode 282-1a, a second transparent electrode 282-2a, a second transparent electrode 282-3a), a plurality of third electrodes 283 (for example, a third electrode 283-1a, a third electrode 283-2a, a third electrode 283-3a), a fourth transparent electrode 284, a first alignment film 214a, a second alignment film 224a, and a liquid crystal layer 260a.

Configurations of the first substrate 211a, the second substrate 221a, the plurality of first transparent electrodes 281, the plurality of second transparent electrodes 282, the first alignment film 214a, the second alignment film 224a, and the liquid crystal layer 260a are similar to the configurations of the first substrate 111a, the second substrate 121a, the plurality of first transparent electrodes 181, the plurality of second transparent electrodes 182, the first alignment film 114a, the second alignment film 124a, and the liquid crystal layer 160a, respectively. Therefore, the configurations of the first substrate 211a, the second substrate 221a, the plurality of first transparent electrodes 281, the plurality of second transparent electrodes 282, the first alignment film 214a, the second alignment film 224a, and the liquid crystal layer 260a will be described as necessary.

The plurality of third electrodes 283 is arranged on the second substrate 221a. The plurality of third electrodes 283 functions as a light-shielding film. The fourth transparent electrode 284 is arranged to cover the plurality of third electrodes 283 and the second substrate 221a and to be in contact with the plurality of third electrodes 283 and the second substrate 221a. The first transparent electrode 281 and the second transparent electrode 282 on the first substrate 211a are arranged to face the third electrode 283 and the fourth transparent electrode 284 on the second substrate 221a.

In addition, similar to the lighting device 100, the first substrate 211a and the second substrate 221a of the lighting device 200 are adhered using a sealing material (not shown), and the liquid crystal layer 260a containing liquid crystals of the lighting device 200 is provided in a space surrounded by the first alignment film 214a, the second alignment film 224a, and the sealing material.

Each of the plurality of first transparent electrodes 281, the plurality of second transparent electrodes 282, and the plurality of third electrodes 283 extends in the y-axis direction. The plurality of third electrodes 283 is arranged with a gap along the x-axis direction.

Similar to the plurality of first transparent electrodes 281, the plurality of second transparent electrodes 282, and the plurality of third electrodes 283, the fourth transparent electrode 284 functions as an electrode to generate an electric field in the liquid crystal layer 260a. For example, transparent conductive materials, such as indium tin oxide (ITO) or indium zinc oxide (IZO), are used as the plurality of first transparent electrodes 281, the plurality of second transparent electrodes 282, and the fourth transparent electrode 284.

The alignment characteristics are given to the first alignment film 214a so that the alignment direction of the liquid crystal molecules on the first substrate 211a side of the first liquid crystal cell 210a is orthogonal to the extending direction of the plurality of first transparent electrodes 281 and the plurality of second transparent electrodes 282. For example, when the direction of the long axes of the first transparent electrode 281 and the second transparent electrode 282 are orthogonal to the direction of alignment treatment (x-axis direction), the direction of alignment treatment coincides with the direction of the electric field generated when a voltage difference occurs between the first transparent electrode 281 and the second transparent electrode 282. As a result, the liquid crystal optical element 10 has a high light extraction efficiency.

In addition, the alignment characteristics are given to the second alignment film 224a that the alignment direction of the liquid crystal molecules on the second substrate 221a side of the first liquid crystal cell 210a is parallel to the extending direction of the plurality of third electrodes 283.

In FIG. 17 and FIG. 18, for convenience, arrows and symbols with x in circles are used to indicate the alignment direction of the liquid crystal molecules in the liquid crystal layer 260a. The arrows indicate the alignment direction of the liquid crystal molecules aligned parallel to the drawing plane, and the symbols with x in circles indicate the alignment direction of the liquid crystal molecules aligned perpendicular to the drawing plane. For example, the alignment direction of the liquid crystal molecules on the first substrate 211a side is the x-axis direction, and the alignment direction of the liquid crystal molecules on the second substrate 221a side is the y-axis direction.

As shown in FIG. 17, the liquid crystal molecules in the cross-sectional structure in the x-axis direction of the liquid crystal optical element 20 are aligned so that the alignment direction changes from the x-axis direction to the y-axis direction and is rotated by 90 degrees from the first substrate 211a side to the second substrate 221a side.

As shown in FIG. 18, the liquid crystal molecules in the cross-sectional structure in the x-axis direction of the liquid crystal optical element 20 are aligned so that the alignment direction changes from the y-axis direction to the x-axis direction and is rotated by 90 degrees from the first substrate 211a side to the second substrate 221a side. In addition, FIG. 17 and FIG. 18 show the liquid crystal optical element 20 in a state where no voltage is supplied to the transparent electrodes of the first liquid crystal cell 210a and the second liquid crystal cell 210b.

The second liquid crystal cell 210b includes a first substrate 211b, a second substrate 221b, the plurality of first transparent electrodes 281 (e.g., a first transparent electrode 281-1b, a first transparent electrode 281-2b), the plurality of second transparent electrodes 282 (e.g., a second transparent electrode 282-1b, a second transparent electrode 282-2b, a second transparent electrode 282-3b), the plurality of third electrodes 283 (e.g., a third electrode 283-1b, a third electrode 283-2b, a third electrode 283-3b), the fourth transparent electrode 284, a first alignment film 214b, a second alignment film 224b, and a liquid crystal layer 260b. The first substrate 211b, the second substrate 221b, the plurality of first transparent electrodes 281, the plurality of second transparent electrodes 282, the plurality of third electrodes 283, the fourth transparent electrode 284, the first alignment film 214b, the second alignment film 224b, and the liquid crystal layer 260b each have a configuration and function similar to the first substrate 211a, the second substrate 221a, the plurality of first transparent electrodes 281, the plurality of second transparent electrodes 282, the plurality of third electrodes 283, the fourth transparent electrode 284, the first alignment film 214a, the second alignment film 224a, and the liquid crystal layer 260a, respectively. Therefore, the description of the second liquid crystal cell 210b will be omitted here.

In a plan view, the first transparent electrodes 281 provided in the first liquid crystal cell 210a and the second liquid crystal cell 210b overlap so that their extending directions (y-axis direction) coincide with each other. Similarly, the same-named transparent electrodes provided in the first liquid crystal cell 210a and the second liquid crystal cell 210b overlap so that their extending directions (y-axis direction) coincide. That is, the lighting device 200 includes a configuration in which the liquid crystal cells with the same configuration (the first liquid crystal cell 210a and the second liquid crystal cell 210b) overlap. In addition, as shown in FIG. 17 and FIG. 18, among the pair of upper and lower substrates forming the first liquid crystal cell 210a and the second liquid crystal cell 210b, the lower substrate (the substrate on the light source side) is the first substrate 211a and the first substrate 211b.

As described in the section “1-1. Configuration of Lighting Device 200,” the basic configuration and function of the first liquid crystal cell 210a and the second liquid crystal cell 210b are the same. Therefore, when the first substrate 211a and the first substrate 211b, the second substrate 221a and the second substrate 221b, the plurality of first transparent electrodes 281, the plurality of second transparent electrodes 282, the plurality of third electrodes 283, the fourth transparent electrode 284, the first alignment film 214a and the first alignment film 214b, the second alignment film 224a and the second alignment film 224b, the liquid crystal layer 260a and the liquid crystal layer 260b are distinguished, they will be described using their respective names. When the components included in the first liquid crystal cell 210a and the second liquid crystal cell 210b described above are not distinguished, the components included in the first liquid crystal cell 210a and the second liquid crystal cell 210b will be described as the first substrate 211, the second substrate 221, the plurality of first transparent electrodes 281, the plurality of second transparent electrodes 282, the plurality of third electrodes 283, a plurality of fourth transparent electrodes 284, the first alignment film 214, the second alignment film 224, and the liquid crystal layer 260.

### 2-3. Arrangement of Transparent Electrodes

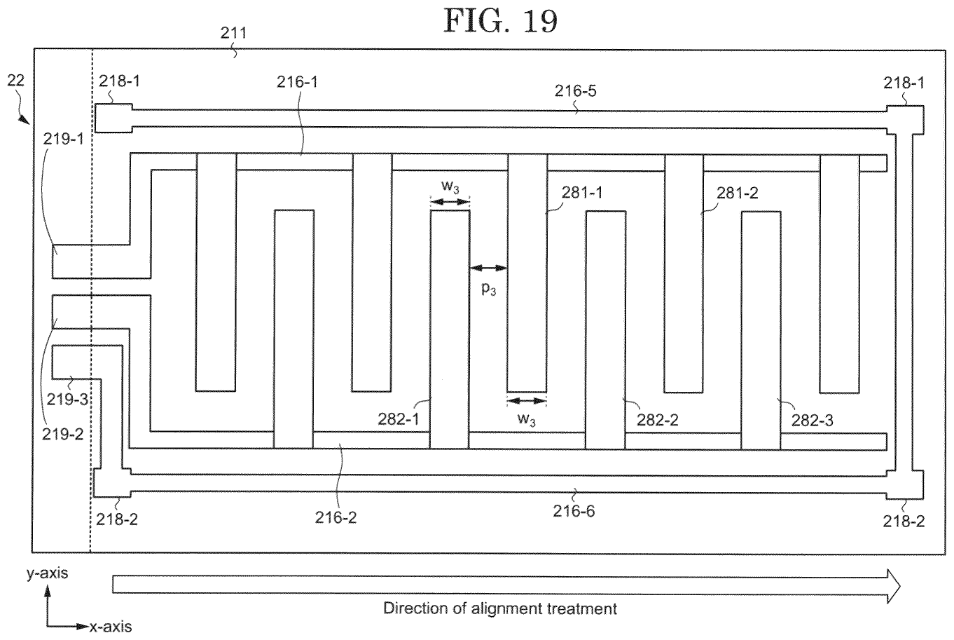

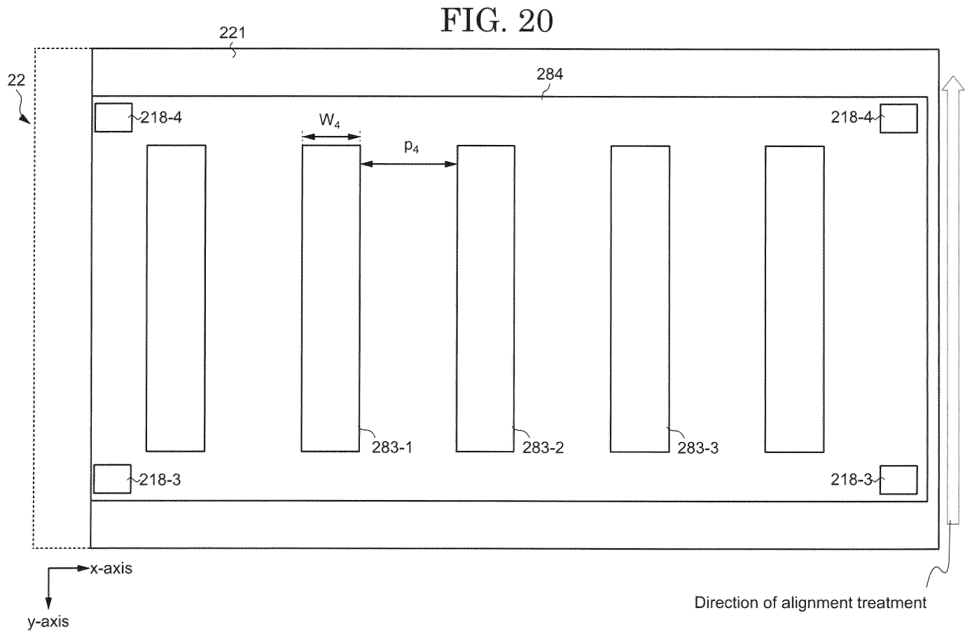

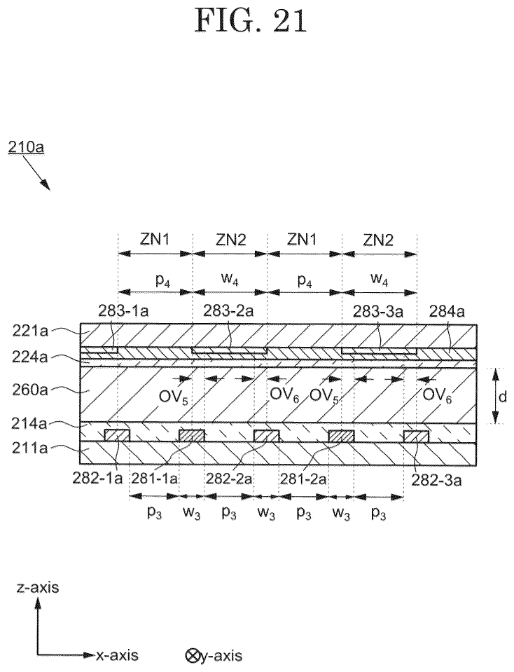

An overview of each electrode of the liquid crystal optical element 20 will be described with reference to FIG. 16 and FIG. 19 to FIG. 21. FIG. 19 is a schematic plan view showing an arrangement of the plurality of first transparent electrodes 281 and the plurality of second transparent electrodes 282 on the first substrate 211 of the liquid crystal optical element 20. FIG. 20 is a schematic plan view showing an arrangement of the plurality of third electrodes 283 and the fourth transparent electrode 284 on the second substrate 221 of the liquid crystal optical element 20. FIG. 21 is a cross-sectional view showing a part of a cross-sectional structure of the liquid crystal optical element 20. In addition, FIG. 21 corresponds to the cross-sectional structure of the first liquid crystal cell 210a along the line C1-C2 shown in FIG. 16. Configurations that are the same as or similar to those in FIG. 16 to FIG. 18 will be described as necessary.

The cross-sectional structure of the first liquid crystal cell 210a is the same as the cross-sectional structure of the second liquid crystal cell 210b, and the cross-sectional structure of the first liquid crystal cell 210a will be described here, and the cross-sectional structure of the second liquid crystal cell 210b will be described as necessary.

First, an overview of each electrode of the liquid crystal optical element 20 in a plan view will be described with reference to FIG. 16, FIG. 19, and FIG. 20. As shown in FIG. 19, in a plan view, the plurality of first transparent electrodes 281, the plurality of second transparent electrodes 282, a first terminal 219-1, and a second terminal 219-2 are provided on the first substrate 211. In addition, a fifth wiring 216-5, a sixth wiring 216-6, a plurality of first power supply terminals 218-1, a plurality of second power supply terminals 218-2, and a third terminal 219-3 are provided on the first substrate 211.

The plurality of first transparent electrodes 281 and the plurality of second transparent electrodes 282 are supplied with control signals (voltages) from the control device 40, and have functions of transmitting, reducing transmission, diffusing, and refracting the light emitted from the light source 30.

The plurality of first transparent electrodes 281 includes the first transparent electrode 281-1. The plurality of second transparent electrodes 282 includes the second transparent electrode 282-1 and the second transparent electrode 282-2. The long axes of the plurality of first transparent electrodes 281 and the plurality of second transparent electrodes 282 extend in the y-axis direction, and the first transparent electrode 281 and the second transparent electrode 282 are alternately arranged along the x-axis direction.

A width of the first transparent electrode 281 and a width of the second transparent electrode 282 (width in the x-axis direction) are a third width w₃. An inter-electrode distance in the x-axis direction (electrode distance) between the first transparent electrode 281 and the second transparent electrode 282 is a third inter-electrode distance p₃. In the lighting device 200, the third width w₃ is different from the third inter-electrode distance p₃. The width of the first transparent electrode 281 and the width of the second transparent electrode 282 may be different from each other.

In addition, a cell gap d is smaller (narrower) than the third inter-electrode distance p₃. example, the cell gap d of the lighting device 200 has a configuration similar to the cell gap d of the lighting device 100. For example, the cell gap d of the lighting device 200 is 30 μm. Since the cell gap d is smaller (narrower) than the third inter-electrode distance p₃, the lateral electric field generated on the first substrate 211a side and the second substrate 112a side affects the liquid crystal molecules positioned near the center between the first substrate 211a and the second substrate 112a, and the lighting device 200 can bend the incident light 180.

The plurality of first transparent electrodes 281 is electrically connected to a first wiring 216-1, and the first wiring 216-1 is electrically connected to the first terminal 219-1. The first wiring 216-1 may be formed under the plurality of first transparent electrodes 281 or may be formed on the plurality of first transparent electrodes 281. In addition, the first wiring 216-1 may be formed in the same layer as the plurality of first transparent electrodes 281. The plurality of second transparent electrodes 282 is electrically connected to the second wiring 216-2, and the second wiring 216-2 is electrically connected to the second terminal 219-2. The second wiring 216-2 may be formed under the plurality of second transparent electrodes 282 or may be formed on the plurality of second transparent electrodes 282. In addition, the second wiring 216-2 may be formed in the same layer as the plurality of second transparent electrodes 282. For example, the plurality of first transparent electrodes 281 and the plurality of second transparent electrodes 282 of the lighting device 200 are formed in the same layer as the first wiring 216-1 and the second wiring 216-2.

The fifth wiring 216-5 is electrically connected to the plurality of first power supply terminals 218-1, the sixth wiring 216-6, the plurality of second power supply terminals 218-2, and the third terminal 219-3.

The first alignment film 214 arranged on the first substrate 211 is subjected to an alignment treatment in the x-axis direction (the direction indicated by the white arrow in FIG. 19). In this case, the long axes of the liquid crystal molecules forming the liquid crystal layer 260 on the first substrate 211 side are aligned along the x-axis direction. That is, the alignment direction (x-axis direction) of the first alignment film 214 and the extending direction (y-axis direction) of the plurality of first transparent electrodes 281 and the plurality of second transparent electrodes 282 are orthogonal.

As shown in FIG. 20, in a plan view, the plurality of third electrodes 283, the fourth transparent electrode 284, and a plurality of third power supply terminals 218-3, as well as a plurality of fourth power supply terminals 218-4, are provided on the second substrate 221. The plurality of third electrodes 283, the plurality of third power supply terminals 218-3, and the plurality of fourth power supply terminals 218-4 may be formed between the second substrate 221 and the fourth transparent electrode 284, or may be formed on the fourth transparent electrode 284 formed on the second substrate 221. For example, the plurality of third electrodes 283, the fourth transparent electrode 284, the plurality of third power supply terminals 218-3, and the plurality of fourth power supply terminals 218-4 are formed on the second substrate 221 and between the second substrate 221 and the fourth transparent electrode 284. In addition, the plurality of third electrodes 283, the fourth transparent electrode 284, the plurality of third power supply terminals 218-3, and the plurality of fourth power supply terminals 218-4 are covered with the fourth transparent electrode 284 and are in contact with the fourth transparent electrode 284. The plurality of third electrodes 283 and the plurality of third power supply terminals 218-3 are electrically connected to the fourth transparent electrode 284.

Similar to the plurality of first transparent electrodes 281 and the plurality of second transparent electrodes 282, the plurality of third electrodes 283 and the fourth transparent electrode 284 are supplied with control signals (voltages) from the control device 40, and have functions of transmitting, reducing transmission, diffusing, and refracting the light emitted from the light source 30.

The plurality of third electrodes 283 includes the third electrode 283-1, the third electrode 283-2, and the third electrode 283-3. The long axes of the plurality of third electrodes 283 extend in the y-axis direction, and the third electrodes 283 are arranged with a gap along the x-axis direction. A width of the third electrode 283 is a fourth width w₄. An inter-electrode distance (electrode distance) in the x-axis direction between the adjacent third electrodes 283 is a fourth inter-electrode distance p₄. In the lighting device 200, the fourth width w₄ is wider (thicker) than the third width w₃, and the third inter-electrode distance p₃ is narrower (thinner) than the fourth inter-electrode distance p₄. The cell gap d is narrower than the fourth width w₄.

In the liquid crystal cell 210, the plurality of first transparent electrodes 281 and the plurality of second transparent electrodes 282 face the plurality of third electrodes 283 and the fourth transparent electrode 284 via the liquid crystal layer 260a. In addition, the extending direction (y-axis direction) of the plurality of first transparent electrodes 281 and the plurality of second transparent electrodes 282 is parallel to the extending direction (y-axis direction) of the plurality of third electrodes 283.

When the first substrate 211 is bonded to the second substrate 221, each of the plurality of first power supply terminals 218-1 is electrically connected to the corresponding third power supply terminal 218-3, and each of the plurality of second power supply terminals 218-2 is electrically connected to the corresponding fourth power supply terminal 218-4. As a result, the first wiring 216-1 and the sixth wiring 216-6 are electrically connected to the plurality of third electrodes 283 and the fourth transparent electrode 284. For example, the first power supply terminal 218-1 and the third power supply terminal 218-3, as well as the second power supply terminal 218-2 and the fourth power supply terminal 218-4, can be electrically connected using silver paste or conductive particles. In addition, the conductive particles include particles coated with metal.

For example, as shown in FIG. 16, FIG. 19, and FIG. 20, the length of the second substrate 221 along the x-axis direction is shorter than the length of the first substrate 211 along the x-axis direction. The first terminal 219-1, the second terminal 219-2, and the third terminal 219-3 are provided in the terminal portion 22 on the first substrate 211. As a result, when the first substrate 211 is bonded to the second substrate 221, the first terminal 219-1, the second terminal 219-2, and the third terminal 219-3 are exposed without being covered with the second substrate 221.

Therefore, in the first liquid crystal cell 210a, the terminal portion 22a can be easily bonded to the first flexible wiring board 11a, and can be easily electrically connected. As a result, the plurality of first transparent electrodes 281 is supplied with control signals (voltages) from the control device 40 (see FIG. 16) via the first flexible wiring board 11a, the terminal portion 22a, the first terminal 219-1, and the first wiring 216-1. The plurality of second transparent electrodes 282 is supplied with control signals (voltages) from the control device 40 via the first flexible wiring board 11a, the terminal portion 22a, the second terminal 219-2, and the second wiring 216-2. The plurality of third electrodes 283 and the fourth transparent electrode 284 are supplied with control signals (voltages) from the control device 40 via the first flexible wiring board 11a, the terminal portion 22a, the third terminal 219-3, the fifth wiring 216-5, the plurality of first power supply terminals 218-1, the sixth wiring 216-6, the plurality of second power supply terminals 218-2, the plurality of third power supply terminals 218-3, and the plurality of fourth power supply terminals 218-4. Similar to the first liquid crystal cell 210a, the terminal portion 22b of the second liquid crystal cell 210b can also be easily bonded with the second flexible wiring board 11b and easily electrically connected. In addition, similar to the first liquid crystal cell 210a, each electrode within the second liquid crystal cell 210b is also supplied with control signals (voltages) from the control device 40.

Metal materials can be used to form the first wiring 216-1, second wiring 216-2, the fifth wiring 216-5, the sixth wiring 216-6, the plurality of first power supply terminals 218-1, the plurality of third power supply terminals 218-3, the plurality of second power supply terminals 218-2, the plurality of fourth power supply terminals 218-4, the first terminal 219-1, the second terminal 219-2, the third terminal 219-3, and the plurality of third electrodes 283. For example, the metal materials include aluminum and molybdenum.

Next, a part of a cross-sectional structure of the liquid crystal optical element 20 will be described with reference to FIG. 21.

The first transparent electrode 281-1a is sandwiched between two adjacent second transparent electrodes 282-1a and 282-2a. The first transparent electrode 281-1a overlaps in the z-axis direction with the end portion of the third electrode 283-2a on the third electrode 283-1a side and the space between the third electrode 283-1a and the third electrode 283-2a.

The space between the first transparent electrode 281-1a and the second transparent electrode 282-1a overlaps the space between the third electrode 283-1a and the third electrode 283-2a in the z-axis direction.

The second transparent electrode 282-1a overlaps the end portion of the third electrode 283-1a on the third electrode 283-2a side and the space between the third electrode 283-1a and the third electrode 283-2a in the z-axis direction.

The first transparent electrode 281-2a is formed in the same manner as the first transparent electrode 281-1a. The second transparent electrode 282-2a and the second transparent electrode 282-3a are formed in the same manner as the second transparent electrode 282-1a.

The third electrode 283-2a is sandwiched between two adjacent third electrodes 283-1a and 183-3a. The fourth transparent electrode 284 is arranged between the third electrode 283-1a and the third electrode 283-2a, between the third electrode 283-2a and the third electrode 283-3a, the top surface of the third electrode 283-1a, the top surface of the third electrode 283-2a, and the top surface of the third electrode 283-3a.

The first liquid crystal cell 210a includes the plurality of first regions ZN1 and the plurality of second regions ZN2. The plurality of first regions ZN1 and the plurality of second regions ZN2 are alternately arranged along the x-axis direction.

The first region ZN1 is adjacent to the second region ZN2. In addition, the first region ZN1, along the z-axis direction, includes a region where the space between the first transparent electrode 281-1a and the second transparent electrode 282-1a overlaps the space between the third electrode 283-1a and the third electrode 283-2a, a region where the space between the third electrode 283-1a and the third electrode 283-2a overlaps the end portion of the first transparent electrode 281-1a on the second transparent electrode 282-1a side, and a region where the space between the third electrode 283-1a and the third electrode 283-2a overlaps the end portion of the second transparent electrode 282-1a on the first transparent electrode 281-1a side. That is, the first region ZN1, along the z-axis direction, includes a region where the space between the first transparent electrode 281 and the second transparent electrode 282 overlaps the space between the adjacent third electrodes 283, a region where the space between the adjacent third electrodes 283 overlaps the end portion of the first transparent electrode 281, and a region where the space between the adjacent third electrodes 283 overlaps the end portion of the second transparent electrode 282.

The second region ZN2, along the z-axis direction, includes a region where the space between the first transparent electrode 281-1a and the second transparent electrode 282-2a overlaps the opposing third electrode 283-2a, a region where the end portion of the first transparent electrode 281-1a on the second transparent electrode 282-2a side overlaps the end portion of the opposing third electrode 283-2a on the third electrode 283-1a side, and a region where the end portion of the second transparent electrode 282-2a on the first transparent electrode 281-1a side overlaps the end portion of in the opposing third electrode 283-2a on the third electrode 283-1a side. That is, the second region ZN2, along the z-axis direction, includes a region where the space between the first transparent electrode 281 and the second transparent electrode 282 overlaps the opposing third electrode 283, a region where the end portion of the first transparent electrode 281 overlaps the opposing third electrode 283, and a region where the end portion of the second transparent electrode 282 overlaps the opposing third electrode 283.

A width OV₅ is the width along the z-axis where the end portion of the first transparent electrode 281-1a on the second transparent electrode 282-2a side overlaps the end portion of the third electrode 283-2a on the third electrode 283-1a side. In addition, the width OV₅ is the width along the z-axis where the end portion of the first transparent electrode 281-2a on the second transparent electrode 282-3a side overlaps the end portion of the third electrode 283-3a on the third electrode 283-2a side. That is, the width OV₅ is the width along the z-axis where the first transparent electrode 281 overlaps the end portion of the third electrode 283.

A width OV₆ is the width along the z-axis where the end portion of the second transparent electrode 282-2a on the first transparent electrode 281-1a side overlaps the end portion of the third electrode 283-2a on the third electrode 283-3a side. In addition, the width OV₆ is the width along the z-axis where the end portion of the second transparent electrode 282-3a overlaps the end portion of the third electrode 283-3a. That is, the width OV₆ is the width where the end portion of the second transparent electrode 282 overlaps the end portion of the third electrode 283.

The cell gap d may be a distance between the surface where the liquid crystal layer 260a and the first alignment film 214a contact each other, or may be a distance between the first substrate 211a and the second substrate 221a. For example, the cell gap d of the lighting device 200 is a distance between the surface where the liquid crystal layer 260a and the first alignment film 214a contact each other.

### 2-4. Control of Light Distribution by Liquid Crystal Optical Element 20

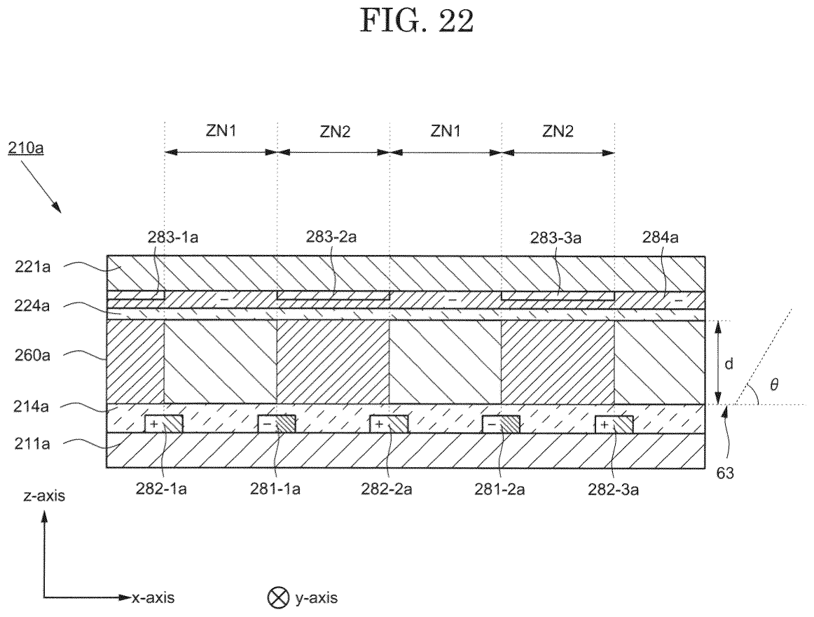

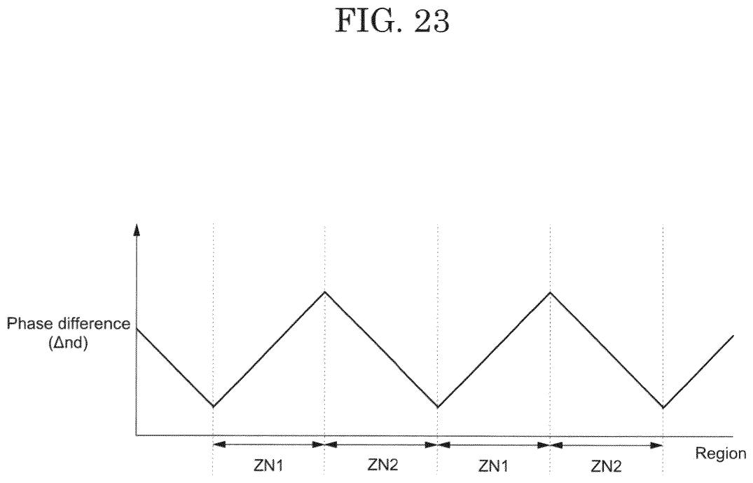

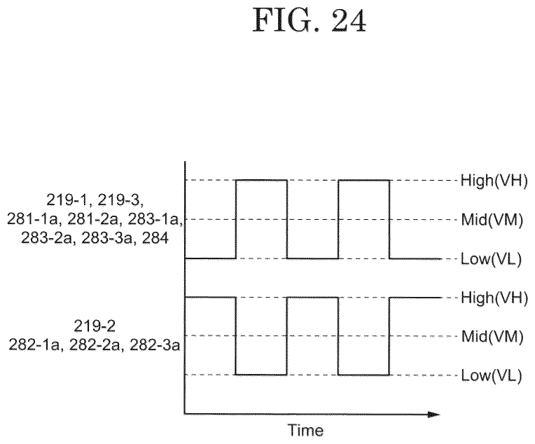

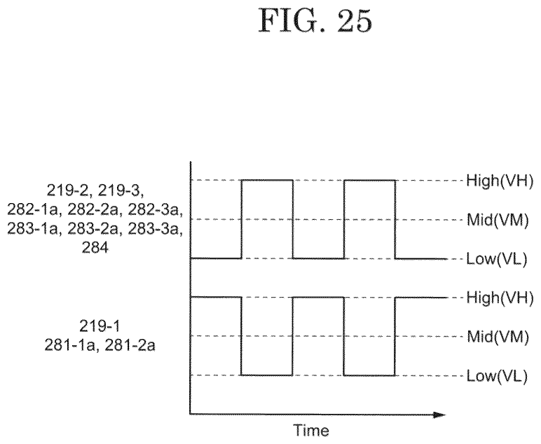

The light distribution using the liquid crystal optical element 20 will be described with reference to FIG. 22 to FIG. 25. FIG. 22 is a cross-sectional view for explaining the light distribution using the liquid crystal optical element 20. FIG. 23 is a diagram showing a relationship between each region and the phase difference in the first liquid crystal cell 210a. FIG. 24 and FIG. 25 are timing charts showing the voltages supplied to the terminals included in the liquid crystal optical element 20. Configurations that are the same as or similar to those in FIG. 1 to FIG. 21 will be described as necessary.

Next, the liquid crystal optical element 20 in a state where a voltage is supplied to each transparent electrode of the first liquid crystal cell 210a will be described with reference to FIG. 22 to FIG. 25. In addition, since the configuration and function of the second liquid crystal cell 210b are similar to those of the first liquid crystal cell 210a, they will be described as necessary.

When different control signals (voltages) are supplied from the control device 40 to the first transparent electrode 281 and the second transparent electrode 282 adjacent to each other among the plurality of first transparent electrodes 281 and the plurality of second transparent electrodes 282, a voltage difference occurs between the first transparent electrode 281 and the second transparent electrode 282 adjacent to each other. As a result, an electric field (first electric field) is generated between the first transparent electrode 281 and the second transparent electrode 282 adjacent to each other. The same control signal (voltage) as either the plurality of first transparent electrodes 281 or the plurality of second transparent electrodes 282 is supplied from the control device 40 to the plurality of third electrodes 283 and the fourth transparent electrode 284. For example, the first electric field is referred to as the lateral electric field.

In this case, a voltage difference occurs between one of the first transparent electrode 281 and the second transparent electrode 282, which is supplied with a different control signal from the plurality of third electrodes 283 and the fourth transparent electrode 284, and the opposing plurality of third electrodes 283 and the fourth transparent electrode 284. As a result, an electric field (third electric field) is generated between one of the first transparent electrode 281 and the second transparent electrode 282, which are supplied with a different control signal from the plurality of third electrodes 283 and the fourth transparent electrode 284, and the opposing plurality of third electrodes 283 and the fourth transparent electrode 284. In addition, since the same control signal (voltage) is supplied between one of the first transparent electrode 281 and the second transparent electrode 282, which are supplied with the same control signal from the plurality of third electrodes 283 and the fourth transparent electrode 284, and the opposing plurality of third electrodes 283 and the fourth transparent electrode 284, no voltage difference occurs.

For example, as shown in FIG. 22 and FIG. 24, a high voltage VH(+) is supplied to the plurality of second transparent electrodes 282 (the second transparent electrodes 282-1a, 282-2a, and 282-3a), and a low voltage VL(−) is supplied to the plurality of first transparent electrodes 281 (the first transparent electrodes 281-1a and 281-2a), the plurality of third electrodes 283 (the third electrodes 283-1a to 283-3a), and the fourth transparent electrode 284.

As a result, the voltage difference (VH−VL) occurs between the second transparent electrode 282 and the first transparent electrode 281, and a lateral electric field is generated. Furthermore, the voltage difference (VH−VL) occurs between the second transparent electrode 282 and the plurality of third electrodes 283 and the fourth transparent electrode 284, and an electric field is generated. In addition, no voltage difference occurs between the plurality of first transparent electrodes 281 and the plurality of third electrodes 283 and the fourth transparent electrode 284, and no electric field is generated. When an electric field is generated, the alignment state of the liquid crystal molecules in the liquid crystal layer 260a affected by the electric field changes.

The relationship between each region and the phase difference according to the cross-sectional view shown in FIG. 22 is shown in FIG. 23. For example, the control angle θ in FIG. 22 and FIG. 23 is less than 90 degrees.

As shown in FIG. 23, the phase difference of the light incident on the first region ZN1 gradually increases as the light proceeds from the first substrate 211a side toward the second substrate 221a side. That is, the light incident on the first region ZN1 is bent as the light proceeds from the first substrate 211a side toward the second substrate 221a side, rotated through the space between the third electrode 283-1a and the third electrode 283-2a, the space between the third electrode 283-2a and the third electrode 283-3a, and the space between the third electrode 283-3a and the adjacent third electrode, and is emitted from the second substrate 221a. For example, the light incident between the second transparent electrode 282-1a and the first transparent electrode 281-1a is bent from the second transparent electrode 282-1a toward the third electrode 283-2a (for example, bent in the right direction) and rotated, based on FIG. 23. In addition, the phase difference of the light incident on the second region ZN2 gradually decreases as the light proceeds from the first substrate 211a side toward the second substrate 221a side. The second region ZN2 includes the third electrode 283 on the second substrate 221a side. Since the third electrode 283 has a light-shielding function, the light incident on the second region ZN2 is not emitted from the second substrate 221a.

As shown in FIG. 22 and FIG. 23, by supplying the high voltage VH or the low voltage VL to each electrode of the lighting device 200, the lighting device 200 can bend the light incident on the incident surface 63 of the first liquid crystal cell 210a (for example, the incident light 180 (see FIG. 16)) at a control angle θ less than 90 degrees, rotate the light, and emit the light from the first liquid crystal cell 210a. The bent light emitted from the first liquid crystal cell 210a transmits through the second liquid crystal cell 210b and is emitted from the second liquid crystal cell 210b. For example, the first polarized light 61 incident on the incident surface 63 of the first liquid crystal cell 210a is bent and rotated, further rotated and transmitted through the second liquid crystal cell 210b, and is emitted from the liquid crystal optical element 20. Since the second polarized light 62 is rotated 90 degrees from the first polarized light 61, the second polarized light 62 is rotated and transmitted through the first liquid crystal cell 210a, bent and rotated similarly to the first polarized light 61 within the second liquid crystal cell 210b, and is emitted from the liquid crystal optical element 20.

In addition, for example, as shown in FIG. 25, the low voltage VL is supplied to the plurality of second transparent electrodes 282 (the second transparent electrodes 282-1a, 282-2a, and 282-3a), and the high voltage VH is supplied to the plurality of first transparent electrodes 281 (the first transparent electrodes 281-1a and 281-2a), the plurality of third electrodes 283 (the third electrodes 283-1a to 283-3a), and the fourth transparent electrode 284.

That is, the high voltage VH is supplied to the second transparent electrode 282-1a, the second transparent electrode 282-2a, the third electrodes 283-1a to 283-3a, and the fourth transparent electrode 284, and the low voltage VL is supplied to the first transparent electrodes 281-1a and 281-1b.

As a result, the voltage difference (VH−VL) occurs between the second transparent electrode 282 and the first transparent electrode 281, and a lateral electric field is generated. Furthermore, the voltage difference (VH−VL) occurs between the second transparent electrode 282 and the plurality of third electrodes 283 and the fourth transparent electrode 284, and an electric field is generated. In addition, no voltage difference occurs between the plurality of first transparent electrodes 281 and the plurality of third electrodes 283 and the fourth transparent electrode 284, and no electric field is generated. When an electric field is generated, the alignment state of the liquid crystal molecules in the liquid crystal layer 260a affected by the electric field changes.

The control angle Θ when the lighting device 200 is operated using the timing chart shown in FIG. 25 is greater than 90 degrees. That is, the phase difference of the light incident on the first region ZN1 changes similar to the second region ZN2 shown in FIG. 23. That is, the light incident on the first region ZN1 is bent as the light proceeds from the first substrate 211a side to the second substrate 221a side, rotated through the space between the third electrode 283-1a and the third electrode 283-2a, the space between the third electrode 283-2a and the third electrode 283-3a, and the space between the third electrode 283-3a and the adjacent third electrode, and is emitted from the second substrate 221a. For example, the light incident between the second transparent electrode 282-1a and the first transparent electrode 281-1a is bent from the first transparent electrode 281-1a toward the third electrode 283-1a (for example, bent in the left direction) and rotated. In addition, the light incident on the second region ZN2 is blocked by the third electrode 283, so the light incident on the second region ZN2 is not emitted from the second substrate 221a.

When either a high voltage VH or low voltage VL is supplied to each electrode of the lighting device 200 using the timing chart shown in FIG. 25, the lighting device 200 can bend the light incident on the incident surface 63 of the first liquid crystal cell 210a (for example, the incident light 180 (see FIG. 16)) at a control angle θ greater than 90 degrees, rotate the light, and then emit the light from the first liquid crystal cell 210a. The bent light emitted from the first liquid crystal cell 210a transmits through the second liquid crystal cell 210b and is emitted from the second liquid crystal cell 210b.

As described above, similar to the lighting device 100, the lighting device 200 can supply a voltage to each electrode included in the liquid crystal optical element 20, thereby causing the light bent at a control angle θ corresponding to the supplied voltage to be emitted from the liquid crystal optical element 20. Therefore, the lighting device 200 can adjust the light distribution direction and light distribution angle using the liquid crystal optical element 20, and can irradiate light with various adjusted light distribution directions and light distribution angles.

### Third Embodiment

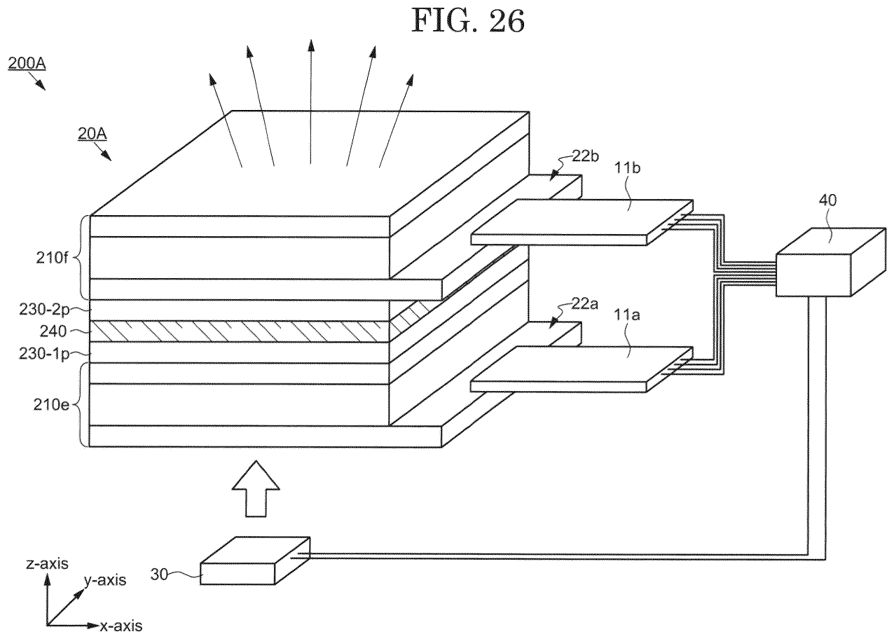

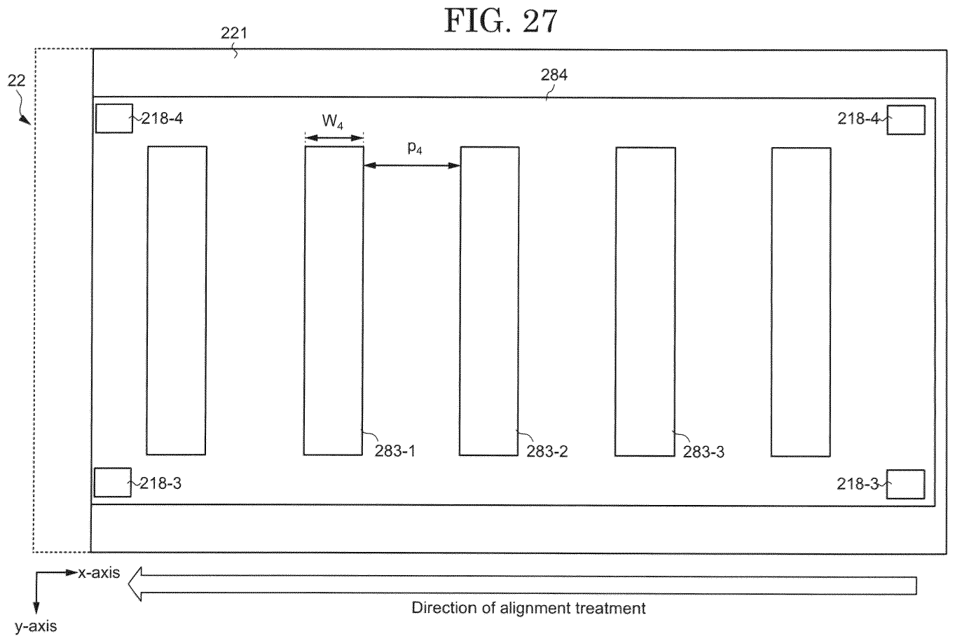

An overview of a configuration of a lighting device 200A according to the third embodiment will be described with reference to FIG. 26 to FIG. 27. FIG. 26 is a schematic perspective view showing the configuration of the lighting device 200A. Compared to the lighting device 200, the alignment treatment of the second alignment film 224a on the second substrate 221 in the lighting device 200A is the same as that of the second alignment film 224a on the second substrate 221 in the lighting device 100. In addition, since the alignment treatment of the second alignment film 224 on the second substrate 221 of the lighting device 200A is the same as the alignment treatment of the second alignment film 224 on the second substrate 221 in the lighting device 100, the lighting device 200A, similar to the lighting device 100, includes a wave plate 240 between a first liquid crystal cell 210e and a second liquid crystal cell 210f. Other configurations of the lighting device 200A are similar to those of the lighting device 100 or the lighting device 200. Therefore, configurations similar to those of the lighting device 100 or the lighting device 200 will be described as necessary. In addition, configurations that are the same as or similar to those in FIG. 1 to FIG. 25 will be described as necessary.

The overview of the configuration of the lighting device 200A will be described with reference to FIG. 26. FIG. 26 is a schematic perspective view showing the configuration of the lighting device 200A.

As shown in FIG. 26, the lighting device 200A includes a liquid crystal optical element 20A, the light source 30, and the control device 40. The liquid crystal optical element 20A includes the first liquid crystal cell 210e, an adhesive layer 230-1p, the wave plate 240, an adhesive layer 230-2p, and the second liquid crystal cell 210f. The adhesive layer 230-1p is provided between the first liquid crystal cell 210e and the wave plate 240, and the adhesive layer 230-2p is provided between the wave plate 240 and the second liquid crystal cell 210f. The first liquid crystal cell 210e, the adhesive layer 230-1p, the wave plate 240, the adhesive layer 230-2p, and the second liquid crystal cell 210f are stacked in this order along the z-axis direction, from the side closer to the light source.

The configuration and function of the wave plate 240 are similar to those of the wave plate 140. The configuration and function of the adhesive layer 230-1p and the adhesive layer 230-2p are similar to those of the adhesive layer 130a. The configuration and function of the light source 30 and the control device 40 are similar to those of the lighting device 100 or the lighting device 200.

The configuration and function of a first liquid crystal cell 230e and a second liquid crystal cell 230f are different from the configuration and function of the first liquid crystal cell 210a and the second liquid crystal cell 210b in the direction of the alignment treatment of the second alignment film 224 on the second substrate 221. The alignment treatment of the second alignment film 224 on the second substrate 221 is similar to the alignment treatment of the second alignment film 224 on the second substrate 221 in the lighting device 100. Specifically, as shown in FIG. 27, the second alignment film 224 is subjected to an alignment treatment in the x-axis direction, and in a direction approaching the terminal portion 22. The configuration and function of the first liquid crystal cell 230e and second liquid crystal cell 230f, except for the direction of the alignment treatment of the second alignment film 224, are similar to those of the first liquid crystal cell 210a and the second liquid crystal cell 210b.

Therefore, when either a high voltage VH or low voltage VL is supplied to each electrode of the lighting device 200A based on the timing chart of FIG. 24 and FIG. 25 used in the lighting device 200, the lighting device 200A can bend and transmit the light incident on the incident surface 63 of the first liquid crystal cell 210e (see FIG. 22) at a control angle θ less than 90 degrees, rotate the light 90 degrees by the wave plate 240, and then transmit the light through the second liquid crystal cell 210f to be emitted from the liquid crystal optical element 20A, the second liquid crystal cell 210f). For example, the first polarized light 61 incident on the incident surface 63 of the first liquid crystal cell 210e is bent and transmitted, rotated 90 degrees by the wave plate 240, transmitted through the second liquid crystal cell 210f, and is emitted from the liquid crystal optical element 20A. Since the second polarized light 62 is rotated 90 degrees from the first polarized light 61, the second polarized light 62 transmits through the first liquid crystal cell 210e, and rotated 90 degrees by the wave plate 240, bent and transmitted similarly to the first polarized light 61 in the second liquid crystal cell 210f, and is emitted from the liquid crystal optical element 20A.

As described above, similar to the lighting device 100 and the lighting device 200, the lighting device 200A can supply a voltage to each electrode included in the liquid crystal optical element 20A, thereby causing the light bent at a control angle θ corresponding to the supplied voltage to be emitted from the liquid crystal optical element 20A. Therefore, the lighting device 200A can adjust the light distribution direction and light distribution angle using the liquid crystal optical element 20A, and can irradiate light with various adjusted light distribution directions and light distribution angles.

### Fourth Embodiment

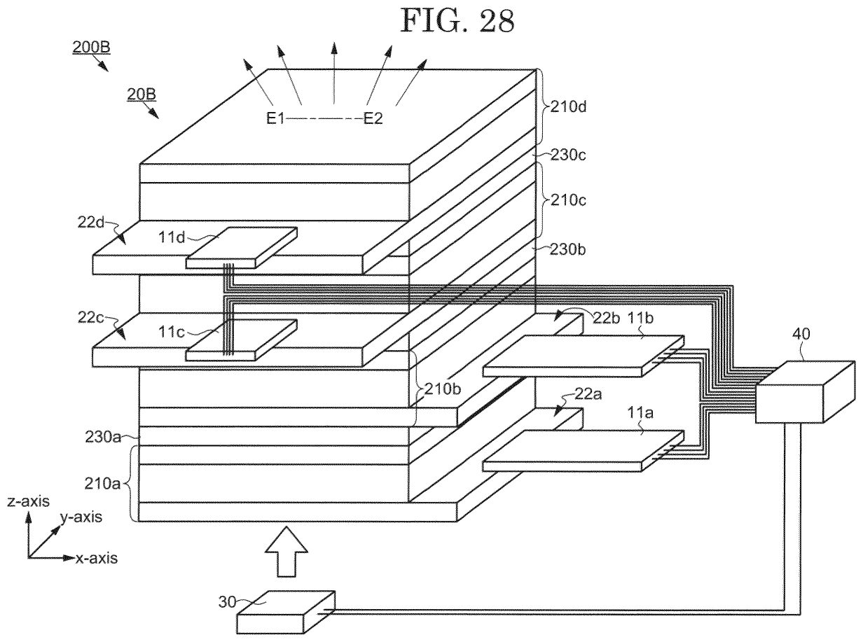

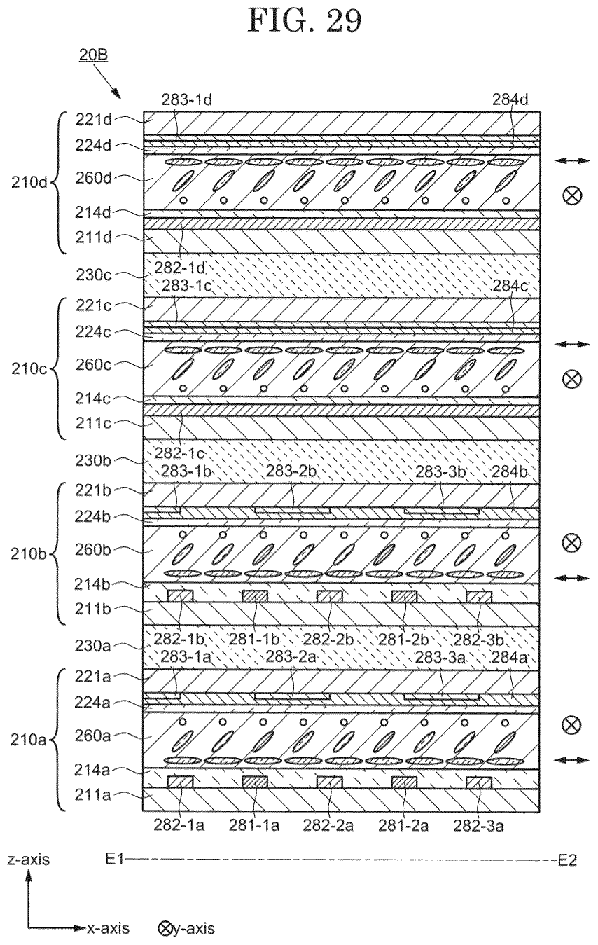

An overview of a configuration of a lighting device 200B according to the fourth embodiment will be described with reference to FIG. 28 and FIG. 29. FIG. 28 is a schematic perspective view showing the configuration of the lighting device 200B. FIG. 29 is a cross-sectional view showing a part of a cross-sectional structure of a liquid crystal optical element 20B. Compared to the lighting device 200, the lighting device 200B includes a configuration in which a liquid crystal optical element having a configuration and function similar to the liquid crystal optical element 20 is rotated 90 degrees along the z-axis direction and overlapped on the liquid crystal optical element 20. Other configurations of the lighting device 200B are similar to those of the lighting device 200. Therefore, configurations similar to those of the lighting device 200 will be described as necessary. In addition, configurations identical or similar to those in FIG. 1 to FIG. 27 will be described as necessary.

First, the overview of the configuration of the lighting device 200B will be described with reference to FIG. 28.

As shown in FIG. 28, the lighting device 200B includes the liquid crystal optical element 20B, the light source 30, and the control device 40. The liquid crystal optical element 20B includes the first liquid crystal cell 210a, the adhesive layer 230a, the second liquid crystal cell 210b, an adhesive layer 230b, a third liquid crystal cell 210c, an adhesive layer 230c, and a fourth liquid crystal cell 210d. The adhesive layer 230a is provided between the first liquid crystal cell 210a and the second liquid crystal cell 210b, the adhesive layer 230b is provided between the second liquid crystal cell 210b and the third liquid crystal cell 210c, and the adhesive layer 230c is provided between the third liquid crystal cell 210c and the fourth liquid crystal cell 210d. The first liquid crystal cell 210a, the adhesive layer 230a, the second liquid crystal cell 210b, the adhesive layer 230b, the third liquid crystal cell 210c, the adhesive layer 230c, and the fourth liquid crystal cell 210d are stacked in this order along the z-axis direction, from the side closer to the light source.

The basic configuration and function of the first liquid crystal cell 210a, the second liquid crystal cell 210b, the third liquid crystal cell 210c, and the fourth liquid crystal cell 210d are the same. Since the configuration and function of the first liquid crystal cell 210a and the second liquid crystal cell 210b are the same as the configuration and function of the first liquid crystal cell 210a and the second liquid crystal cell 210b of the lighting device 200, they will be described as necessary.

The material forming the adhesive layers 230a to 230c may be a material similar to that used for the adhesive layer 130a.

The light source 30 and the control device 40 have the same configuration as the lighting device 100. The control device 40 controls the liquid crystal optical element 20B and the light source 30. Specifically, the control device 40 can supply control signals (voltages) that can control the light distribution direction and alignment angle to the first liquid crystal cell 210a to the fourth liquid crystal cell 210d of the liquid crystal optical element 20B, and also supply control signals (voltages) that can control the lighting and brightness of the light source 30.

The liquid crystal optical element 20B and the light source 30 are electrically connected to the control device 40. For example, the control device 40 is electrically connected to the liquid crystal optical element 20B and the light source 30 via a third flexible wiring board 11c electrically connected to a terminal portion 22c of the first liquid crystal cell 210a, the second flexible wiring board 11b electrically connected to the terminal portion 22b of the second liquid crystal cell 210b, the third flexible wiring board 11c electrically connected to the terminal portion 22c of the third liquid crystal cell 210c, and a fourth flexible wiring board 11d electrically connected to a terminal portion 22d of the fourth liquid crystal cell 210d.

The light emitted from the light source 30 to the liquid crystal optical element 20B is emitted from the first liquid crystal cell 210a, the adhesive layer 230a, the second liquid crystal cell 210b, the adhesive layer 230b, the third liquid crystal cell 210c, the adhesive layer 230c, and the fourth liquid crystal cell 210d. For example, the light transmitted through the liquid crystal optical element 20B is refracted in the x-axis direction or y-axis direction based on the configuration of each electrode included in the liquid crystal cell 210 and the voltage supplied to each electrode from the control device 40. That is, the lighting device 200B can adjust the light distribution direction and light distribution angle using the liquid crystal optical element 20B, and can irradiate light with various adjusted light distribution directions and light distribution angles.

Next, an overview of a configuration of the liquid crystal optical element 20B will be described with reference to FIG. 29. Specifically, FIG. 29 is a schematic cross-sectional view in a zx plane cut along a line E1-E2 shown in FIG. 28.

The third liquid crystal cell 210c has a configuration and function similar to those of the first liquid crystal cell 210a, and the fourth liquid crystal cell 210d has a configuration and function similar to those of the second liquid crystal cell 210b. The lighting device 200B has a configuration in which the liquid crystal optical element (the third liquid crystal cell 210c and the fourth liquid crystal cell 210d having the same structure) is stacked on the liquid crystal optical element 10 described in the lighting device 200 (the first liquid crystal cell 210a and the second liquid crystal cell 210b) rotated by 90 degrees.

The third liquid crystal cell 210c includes a first substrate 211c, a second substrate 221c, the plurality of first transparent electrodes (not shown), the plurality of second transparent electrodes 282 (e.g., a second transparent electrode 282-1c), the plurality of third electrodes 283 (e.g., a third electrode 283-1c), a fourth transparent electrode 284c, a first alignment film 214c, a second alignment film 224c, and a liquid crystal layer 260c.

The fourth liquid crystal cell 210d includes a first substrate 211d, a second substrate 221d, the plurality of first transparent electrodes (not shown), the plurality of second transparent electrodes 282 (e.g., a second transparent electrode 282-1d), the plurality of third electrodes 283 (e.g., a third electrode 283-1d), a fourth transparent electrode 284d, a first alignment film 214d, a second alignment film 224d, and a liquid crystal layer 260d. Each component of the fourth liquid crystal cell 210d is similar to each component of the third liquid crystal cell 210c.

Configurations of the first substrate 211c, the second substrate 221c, the plurality of first transparent electrodes 281, the plurality of second transparent electrodes 282, the first alignment film 214c, the second alignment film 224c, and the liquid crystal layer 260c are similar to the configurations of the first substrate 111a, the second substrate 121a, the plurality of first transparent electrodes 181, the plurality of second transparent electrodes 182, the first alignment film 114a, the second alignment film 124a, and the liquid crystal layer 160a. Therefore, descriptions of the third liquid crystal cell 210c and the fourth liquid crystal cell 210d will be omitted.

The extending direction of the plurality of first transparent electrodes, the plurality of second transparent electrodes 282, and the plurality of third electrodes 283 included in the third liquid crystal cell 210c and the fourth liquid crystal cell 210d is orthogonal to the extending direction of the plurality of first transparent electrodes, the plurality of second transparent electrodes 282, and the plurality of third electrodes 283 included in the first liquid crystal cell 210a and the second liquid crystal cell 210b.

In addition, the direction of an alignment treatment (x-axis direction) of the first substrate 211 of the first liquid crystal cell 210a and the second liquid crystal cell 210b is orthogonal to the direction of an alignment treatment (y-axis direction) of the first substrate 211 of the third liquid crystal cell 210c and the fourth liquid crystal cell 210d. Similar to the first substrate 211, the direction of an alignment treatment (y-axis direction) of the second substrate 221 of the first liquid crystal cell 210a and the second liquid crystal cell 210b is orthogonal to the direction of an alignment treatment (x-axis direction) of the second substrate 221 of the third liquid crystal cell 210c and the fourth liquid crystal cell 210d.

As a result, for example, the first liquid crystal cell 210a can bend and rotate the first polarized light 61 parallel to the y-axis direction into the x-axis direction, the second liquid crystal cell 210b can bend and rotate the second polarized light 62 parallel to the x-axis direction into the x-axis direction, the third liquid crystal cell 210c can bend and advance the first polarized light 61 parallel to the y-axis direction into the y-axis direction, and the fourth liquid crystal cell 210d can bend and rotate the second polarized light 62 parallel to the x-axis direction into the y-axis direction.

Therefore, the lighting device 200B can bend light in the two axes of the x-axis direction and y-axis direction.

In addition, similar to the lighting device 200, the lighting device 200B can supply each voltage to each electrode included in the liquid crystal optical element 20B, thereby causing the light bent at a control angle θ corresponding to the supplied voltage to be emitted from the liquid crystal optical element 20B. Therefore, the lighting device 200B can adjust the light distribution direction and light distribution angle using the liquid crystal optical element 20B, and can irradiate light with various adjusted light distribution directions and light distribution angles.

The various configurations of the liquid crystal optical element and the lighting device exemplified as an embodiment of the present invention can be appropriately combined and implemented as long as no contradiction is caused. In addition, the various configurations of the liquid crystal optical element and the lighting device exemplified as an embodiment of the present invention can be appropriately interchanged as long as no contradiction is caused. The addition, deletion, or design change of components, or the addition, deletion, or condition change of processes as appropriate by those skilled in the art based on the liquid crystal optical element and the lighting device disclosed in the present specification and drawings are also included in the scope of the present invention as long as they are provided with the gist of the present invention.

Further, it is understood that, even if the effect is different from those provided by each of the embodiments disclosed in the present specification, the effect obvious from the description in the specification or easily predicted by persons ordinarily skilled in the art is apparently derived from the present invention.

What is claimed is:

1. A liquid crystal optical element comprising:
a first liquid crystal cell; and
a second liquid crystal cell overlapping the first liquid crystal cell,
wherein
each of the first liquid crystal cell and the second liquid crystal cell includes:
a first substrate, a first electrode and a second electrode arranged on the first substrate;
a second substrate arranged opposite the first substrate;
a third electrode and a fourth electrode arranged on the second substrate; and
a liquid crystal layer arranged between the first substrate and the second substrate,
wherein
the first electrode and the second electrode are alternately arranged parallel to a first direction, and extend in a second direction intersecting the first direction,
the third electrode and the fourth electrode are arranged alternately parallel to the first direction, and extend in the second direction,
the first electrode overlaps a first end of the third electrode, a space between the third electrode and the fourth electrode, and a first end of the fourth electrode, in a third direction intersecting the first direction and the second direction, and
the fourth electrode overlaps a space between the first electrode and the second electrode and a first end of the second electrode in the third direction.

2. The liquid crystal optical element according to claim 1, wherein
each of the first liquid crystal cell and the second liquid crystal cell includes:
a first alignment film arranged on the first electrode and the second electrode; and
a second alignment film arranged on the third electrode and the fourth electrode and facing the first alignment film.

3. The liquid crystal optical element according to claim 2, wherein
a direction of an alignment treatment of the first alignment film and a direction of an alignment treatment of the second alignment film are parallel to the first direction.

4. The liquid crystal optical element according to claim 1, further comprising a wave plate arranged between the first liquid crystal cell and the second liquid crystal cell.

5. The liquid crystal optical element according to claim 1, wherein
a width of the first electrode is the same as a width of the second electrode and is narrower than a width of the third electrode.

6. The liquid crystal optical element according to claim 1, wherein
the space between the first electrode and the second electrode is wider than the space between the third electrode and the fourth electrode.

7. The liquid crystal optical element according to claim 2, wherein
a cell gap between the first alignment film and the second alignment film along the third direction is narrower than a width of the first electrode.

8. The liquid crystal optical element according to claim 2, wherein
the first electrode, the second electrode, the third electrode, and the fourth electrode include a transparent material.

9. A lighting device comprising:
the liquid crystal optical element according to claim 1; and
a control device,
wherein
the control device is electrically connected to the liquid crystal optical element, and supplies control signals to the first electrode, the second electrode, the third electrode, and the fourth electrode.

10. The lighting device according to claim 9, wherein
the control device supplies a first control signal to the first electrode and the fourth electrode, and a second control signal to the second electrode and the third electrode, and
a polarity of the second control signal is different from a polarity of the first control signal.

11. A liquid crystal optical element comprising:
a first liquid crystal cell; and
a second liquid crystal cell overlapping the first liquid crystal cell,
wherein
each of the first liquid crystal cell and the second liquid crystal cell includes:
a first substrate;
a first electrode, a second-A electrode and a second-B electrode arranged on the first substrate;
a second substrate arranged opposite the first substrate;
a third-A electrode, a third-B electrode and a fourth electrode arranged on the second substrate; and
a liquid crystal layer arranged between the first substrate and the second substrate,
wherein
the first electrode, the second-A electrode and the second-B electrode are alternately arranged parallel to a first direction, and extend in a second direction intersecting the first direction,
the third-A electrode and the third-B electrode are arranged parallel to the first direction, and extend in the second direction,
the fourth electrode is arranged on the second substrate to cover the third-A electrode and the third-B electrode,
the first electrode overlaps a first end of the third-A electrode and a space between the third-A electrode and the third-B electrode, in a third direction intersecting the first direction and the second direction,
the third-A electrode overlaps a space between the first electrode and the second-A electrode, and a first end of the second-A electrode, in the third direction, and
the space between the third-A electrode and the third-B electrode overlaps a space between the first electrode and the second-B electrode.

12. The liquid crystal optical element according to claim 11, wherein
each of the first liquid crystal cell and the second liquid crystal cell further includes:
a first alignment film arranged on the first electrode, the second-A electrode and the second-B electrode; and
a second alignment film arranged on the third-A electrode, the third-B electrode, and the fourth electrode, and facing the first alignment film.

13. The liquid crystal optical element according to claim 12, wherein
a direction of an alignment treatment of the first alignment film is parallel to the first direction, and
a direction of an alignment treatment of the second alignment film is parallel to the second direction.

14. The liquid crystal optical element according to claim 12, wherein
the space between the third-A electrode and the third-B electrode is wider than the space between the first electrode and the second-A electrode, and
a cell gap between the first alignment film and the second alignment film along the third direction is narrower than a width of the third-A electrode and a width of the third-B electrode.

15. The liquid crystal optical element according to claim 11, wherein
the third-A electrode and the third-B electrode include a metal material, and block light transmitted through the first substrate.

16. The liquid crystal optical element according to claim 11, wherein
a direction of an alignment treatment of the first alignment film and a direction of an alignment treatment of the second alignment film are parallel to the first direction.

17. The liquid crystal optical element according to claim 16, further comprising a wave plate arranged between the first liquid crystal cell and the second liquid crystal cell.

18. The liquid crystal optical element according to claim 11, further comprising:
a third liquid crystal cell overlapping the second liquid crystal cell; and
a fourth liquid crystal cell overlapping the third liquid crystal cell,
wherein
the third liquid crystal cell and the fourth liquid crystal cell overlap the second liquid crystal cell by being rotated 90 degrees about an axis parallel to the third direction, and
each of the third liquid crystal cell and the fourth liquid crystal cell includes the first substrate, the first electrode, the second-A electrode, the second-B electrode, the second substrate, the third-A electrode, the third-B electrode, the fourth electrode, and the liquid crystal layer.
